(19) United States
(12) Patent Application Publication
(10) Pub. No.: US 2021/0364610 A1
(43) Pub. Date: Nov. 25, 2021

(54) A MEASUREMENT HEAD FOR DETERMINING A POSITION OF AT LEAST ONE OBJECT

(71) Applicant: trinamiX GmbH, Ludwigshafen am Rhein (DE)

(72) Inventors: Celal Mohan Oeguen, Ludwigshafen (DE); Robert Send, Ludwigshafen (DE); Ingmar Bruder, Ludwigshafen (DE)

(21) Appl. No.: 17/270,525

(22) PCT Filed: Aug. 23, 2019
(86) PCT No.: PCT/EP2019/072622

§ 371 Date: Feb. 23, 2021

(30) Foreign Application Priority Data
Aug. 24, 2018 (EP) 18190749.4

(51) Int. Cl. G01S 7/481; G01S 17/42; G02B 6/36; G02B 26/10

(52) U.S. Cl. CPC G01S 7/4818; G01S 17/42; G02B 26/103; G02B 6/3624; G01S 7/4817

(57) ABSTRACT

Described herein is a measurement head for determining a position of at least one object including at least one transfer device, where the transfer device has at least one focal length in response to at least one incident light beam propagating from the object to the measurement head, and

at least two optical receiving fibers, where at least one of the optical receiving fibers and/or the transfer device has a ratio εᵣ/k≥0.362 (m·K)/W, where k is the thermal conductivity and εᵣ is the relative permittivity.

### FIELD OF THE INVENTION

The invention relates to a measurement head for determining a position of at least one object, a kit and a method for determining a position of at least one object. The invention further relates to various uses of the detector device. The devices, systems, methods and uses according to the present invention specifically may be employed for example in various areas of daily life, gaming, traffic technology, production technology, security technology, photography such as digital photography or video photography for arts, documentation or technical purposes, medical technology or in the sciences. Further, the invention specifically may be used for scanning one or more objects and/or for scanning a scenery, such as for generating a depth profile of an object or of a scenery, e.g. in the field of architecture, metrology, archaeology, arts, medicine, engineering or manufacturing. However, other applications are also possible.

### Prior Art

Fiber optical distance sensors are generally known from prior art. These devices allow separating a location of the distance measurement from measurement electronics. Thus, it is possible to measure in places with rough environments such as harsh chemical environments, high temperature shocks, strong electric field, or environments with a strong mechanical impact such as vibrations, shocks, bending, stretching, beating or other impacts. A fiber optical sensor is described, for example, in PCT/EP2018/056545 filed on Mar. 15, 2018, the full content of which is herewith included by reference.

It is desirable that these fiber optical distance sensors are not application specific but that reliable measurements are possible for several applications such as in different environments. However, known fiber optical distance sensors often comprise materials and optics which turn out too expensive or not useful in harsh environments so that the measurement reliability may suffer or the material itself deteriorates. Further, known fiber optical distance sensor often comprise materials and optics which lead to measurement errors when environmental conditions such as temperature, or electric fields change, making them unsuitable for harsh and varying environmental conditions.

U.S. Pat. No. 9,593,941 B2 describes a clearance detection system and a method using frequency identification. The clearance detection system uses a fiber optic sensor to determine a distance between a target traversing through a target area and a wall of a housing or casing within which the target is rotating. The clearance detection system projects a light field including multiple alternating and diverging illuminated and non-illuminated regions into the target area, collects light reflected off of the target as the target traverses through the light field, generates an oscillatory signal based on the collected reflected light, identifies the dominant frequency of the signal, and uses the dominant frequency to determine the distance.

US 2018/084981 A1 describes an apparatus, method, and system for a spectrally encoded endoscope comprising a focusing lens encompassed by an light guiding component and spacer, wherein the focusing lens is substantially ball or semi-circular in shape, and the refractive index of the focusing lens is greater than the refractive index of the spacer.

WO 2018/091640 A2 describes a detector for determining a position of at least one object. The detector comprises: —at least one transfer device, wherein the transfer device has at least one focal length in response to at least one incident light beam propagating from the object to the detector; —at least two optical sensors, wherein each optical sensor has at least one light sensitive area, wherein each optical sensor is designed to generate at least one sensor signal in response to an illumination of its respective light-sensitive area by the light beam; —at least one evaluation device being configured for determining at least one longitudinal coordinate z of the object by evaluating a quotient signal Q from the sensor signals. The detector is adapted to determine the longitudinal coordinate z of the object in at least one measurement range independent from the object size in an object plane.

### Problem Addressed by the Invention

It is therefore an object of the present invention to provide devices and methods facing the above-mentioned technical challenges of known devices and methods. Specifically, it is an object of the present invention to provide devices and methods which reliably may determine a position of an object in space even in harsh environments, preferably with a low technical effort and with low requirements in terms of technical resources and cost.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

In a first aspect of the present invention a measurement head for determining a position of at least one object is disclosed. As used herein, the term “measurement head” refers to at least one measuring means configured to receive at least one light beam from the object. The measurement head may comprise at least one spacer device configured to accommodate further components of the measurement head such as at least two optical receiving fibers such as at least two optical measurement fibers, as will be outlined in detail below. The measurement head may comprise at least one radially arranged or even radially-symmetric design, in particular in view of an arrangement of the optical receiving fibers. The radially arranged or radially symmetric design may allow enhancing robustness of measurement values, in particular at strong black-and-white contrast in a measured point of the object or for measurements of concave or convex surfaces.

As used herein, the term “object” refers to a point or region emitting at least one light beam. The light beam may originate from the object, such as by the object and/or at least one illumination source integrated or attached to the object emitting the light beam, or may originate from a different illumination source, such as from an illumination source directly or indirectly illuminating the object, wherein the light beam is reflected or scattered by the object. As used herein, the term “position” refers to at least one item of information regarding a location and/or orientation of the object and/or at least one part of the object in space. Thus, the at least one item of information may imply at least one distance between at least one point of the object and the at least one measurement head. As will be outlined in further detail below, the distance may be a longitudinal coordinate or may contribute to determining a longitudinal coordinate of the point of the object. Additionally or alternatively, one or more other items of information regarding the location and/or orientation of the object and/or at least one part of the object may be determined. As an example, additionally, at least one transversal coordinate of the object and/or at least one part of the object may be determined. Thus, the position of the object may imply at least one longitudinal coordinate of the object and/or at least one part of the object. Additionally or alternatively, the position of the object may imply at least one transversal coordinate of the object and/or at least one part of the object. Additionally or alternatively, the position of the object may imply at least one orientation information of the object, indicating an orientation of the object in space.

The measurement head comprises:
at least one transfer device, wherein the transfer device has at least one focal length in response to the at least one incident light beam propagating from the object to the measurement head;
at least two optical receiving fibers, wherein at least one of the optical receiving fibers and/or the transfer device has a ratio εᵣ/k≥0.362 (m·K)/W, wherein k is the thermal conductivity and εᵣ is the relative permittivity.

The term “transfer device”, also denoted as “transfer system”, may generally refer to one or more optical elements which are adapted to modify the light beam, such as by modifying one or more of a beam parameter of the light beam, a width of the light beam or a direction of the light beam. The transfer device may be adapted to guide the light beam onto the optical receiving fibers. The transfer device specifically may comprise one or more of: at least one lens, for example at least one lens selected from the group consisting of at least one focus-tunable lens, at least one aspheric lens, at least one spherical lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system. The transfer device may comprise at least one gradient index (GRIN) lens. The GRIN lens may have a continuous refraction gradient, for example, an axial and/or radial and/or spherical refraction gradient. The f-number of the GRIN lens may be dependent on a lens length. Using GRIN lens may allow miniaturizing optics, in particular using very thin optics. For example, very thin optics with a thickness or diameter of 0.2 mm may be possible. The transfer device may comprise at least one annular axial lens, for example torus form. The annular axial lens may have a plano-convex form, for example, an axial and/or radial and/or spherical curvature.

The transfer device has a focal length in response to the at least one incident light beam propagating from the object to the measurement head. As used herein, the term “focal length” of the transfer device refers to a distance over which incident collimated rays which may impinge the transfer device are brought into a “focus” which may also be denoted as “focal point”. Thus, the focal length constitutes a measure of an ability of the transfer device to converge an impinging light beam. Thus, the transfer device may comprise one or more imaging elements which can have the effect of a converging lens. By way of example, the transfer device can have one or more lenses, in particular one or more refractive lenses, and/or one or more convex mirrors. In this example, the focal length may be defined as a distance from the center of the thin refractive lens to the principal focal points of the thin lens. For a converging thin refractive lens, such as a convex or biconvex thin lens, the focal length may be considered as being positive and may provide the distance at which a beam of collimated light impinging the thin lens as the transfer device may be focused into a single spot. Additionally, the transfer device can comprise at least one wavelength-selective element, for example at least one optical filter. Additionally, the transfer device can be designed to impress a predefined beam profile on the electromagnetic radiation, for example, at the location of the sensor region and in particular the sensor area. The above-mentioned optional embodiments of the transfer device can, in principle, be realized individually or in any desired combination.

The transfer device may have an optical axis. As used herein, the term “optical axis of the transfer device” generally refers to an axis of mirror symmetry or rotational symmetry of the lens or lens system. In particular, the measurement head and the transfer device have a common optical axis. The optical axis of the measurement head may be a line of symmetry of the optical setup of the measurement head. The measurement head may comprise at least one transfer system having at least one lens. The transfer system, as an example, may comprise at least one beam path, with the elements of the transfer system in the beam path being located in a rotationally arranged or even symmetrical fashion with respect to the optical axis. Still, as will also be outlined in further detail below, one or more optical elements located within the beam path may also be off-centered or tilted with respect to the optical axis. In this case, however, the optical axis may be defined sequentially, such as by interconnecting the centers of the optical elements in the beam path, e.g. by interconnecting the centers of the lenses, wherein, in this context, the optical sensors are not counted as optical elements. The optical axis generally may denote the beam path. Therein, the measurement head may have a single beam path along which a light beam may travel from the object to the optical receiving fibers or may have a plurality of beam paths. As an example, a single beam path may be given, or the beam path may be split into two or more partial beam paths. In the latter case, each partial beam path may have its own optical axis. The optical receiving fibers may be located in one and the same beam path or partial beam path. Alternatively, however, the optical receiving fibers may also be located in different partial beam paths.

The transfer device may constitute a coordinate system, wherein a longitudinal coordinate I is a coordinate along the optical axis and wherein d is a spatial offset from the optical axis. The coordinate system may be a polar coordinate system in which the optical axis of the transfer device forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate I. Any direction perpendicular to the z-axis may be considered a transversal direction, and the polar coordinate and/or the polar angle may be considered a transversal coordinate.

The term “light beam” generally may refer to an amount of light emitted and/or reflected into a specific direction. Thus, the light beam may be a bundle of the light rays having a predetermined extension in a direction perpendicular to a direction of propagation of the light beam.

Preferably, the light beams may be or may comprise one or more Gaussian light beams such as a linear combination of Gaussian light beams, which may be characterized by one or more Gaussian beam parameters, such as one or more of a beam waist, a Rayleigh-length or any other beam parameter or combination of beam parameters suited to characterize a development of a beam diameter and/or a beam propagation in space. As used herein, the term “ray” generally refers to a line that is perpendicular to wavefronts of light which points in a direction of energy flow. As used herein, the term “beam” generally refers to a collection of rays. In the following, the terms “ray” and “beam” will be used as synonyms. As further used herein, the term “light beam” generally refers to an amount of light, specifically an amount of light traveling essentially in the same direction, including the possibility of the light beam having a spreading angle or widening angle. The light beam may have a spatial extension. Specifically, the light beam may have a non-Gaussian beam profile. The beam profile may be selected from the group consisting of a trapezoid beam profile; a triangle beam profile; a conical beam profile. The trapezoid beam profile may have a plateau region and at least one edge region. As used herein, the term “beam profile” generally refers to a transverse intensity profile of the light beam. The beam profile may be a spatial distribution, in particular in at least one plane perpendicular to the propagation of the light beam, of an intensity of the light beam. The light beam specifically may be a Gaussian light beam or a linear combination of Gaussian light beams, as will be outlined in further detail below. Other embodiments are feasible, however. The measurement head may comprise the at least one transfer device configured for one or more of adjusting, defining and determining the beam profile, in particular a shape of the beam profile. As used herein, the term “light” generally refers to electromagnetic radiation in one or more of the visible spectral range, the ultraviolet spectral range and the infrared spectral range. Therein, the term visible spectral range generally refers to a spectral range of 380 nm to 780 nm. The term infrared spectral range generally refers to electromagnetic radiation in the range of 780 nm to 1 mm, preferably in the range of 780 nm to 3.0 micrometers. The term ultraviolet spectral range generally refers to electromagnetic radiation in the range of 1 nm to 380 nm, preferably in the range of 100 nm to 380 nm. Preferably, light as used within the present invention is visible light, i.e. light in the visible spectral range.

As used herein, the term “optical fiber” has its ordinary meaning and specifically refers to at least one optical element configured to guide at least partially at least one light beam impinging on an entrance face of the optical fiber to an exit face of the optical fiber. The entrance face and the exit face may be separated from each other by a certain distance and may be connected by at least one light guiding structure. As used herein, the term “to guide at least partially” refers to perfect light guiding and to configurations in which absorptions and reflections from the entrance face and/or absorptions and reflections from or out of the light guiding structure are possible. Specifically, each of the optical receiving fibers may be and/or may comprise at least one optical measurement fiber. As used herein, the term “optical measurement fiber” refers to the at least one angle dependent optical element having at least one optical fiber configured to provide an incoming light beam to at least one optical sensor. The optical receiving fiber may comprise two ends. The optical receiving fiber may comprise at least one receiving end adapted to receive at least one light beam originating from the object. The optical receiving fiber may comprise at least one exit-end from which the light beam originating from the object leaves the optical receiving fiber. The receiving end may also be denoted as at least one entrance face of the at least one receiving fiber which may also be denoted as the position where the light beam travelling from the object to the measurement head impinges on the optical receiving fiber. Without wishing to be bound by this theory, it is believed that the angle of incidence of a light beam received by the optical receiving fiber is preserved such that the angle of incidence is equal to the exit-angle, assuming that the angle of incidence is equal or smaller than the acceptance angle of the optical receiving fiber. Thus, distance information encoded in the light beam can be essentially preserved and can be evaluated using a combined signal Q, which will be described in detail below.

The optical receiving fibers may be designed such that the degree of transmission may be highest for incoming light rays parallel, i.e. at an angle of 0°, to the optical receiving fiber, neglecting reflection effects. The optical receiving fibers may be designed such that for higher angles, for example angles from 1° to 10°, the degree of transmission may decrease smoothly to around 80% of the degree of transmission for parallel light rays and may remain at this level constantly up to an acceptance angle of the optical receiving fiber. As used herein, the term “acceptance angle” may refer to an angle above which total reflection within the respective optical receiving fiber is not possible such that the light rays are reflected out of the optical receiving fiber. The optical receiving fibers may be designed that at the acceptance angle, the degree of transmission may steeply fall to zero. Light rays having a large angle of incidence may be cut-off.

The optical receiving fibers may be adapted to transmit at least parts of the incident light beam which are not absorbed and/or reflected, between two ends of the respective optical receiving fiber such as an entrance end and an exit end. The optical receiving fibers may have a length and may be adapted to permit transmission over a distance. The optical receiving fibers may comprise at least one material selected from the group consisting of: silica, aluminosilicate glass, germane silicate glass, fluorozirconate, rare earth doped glass, fluoride glass, chalcogenide glasses, sapphire, doped variants, especially for silica glass, phosphate glass, PMMA, polystyrene, fluoropolymers such as poly(perfluoro-butenylvinyl ether), or the like. The optical receiving fibers may be a single or multi-mode fiber. Each of the optical receiving fibers may be or may comprise one or more of a step index fiber, a polarizing fiber, a polarization maintaining fiber, a plastic optical receiving fiber or the like.

Each of the optical receiving fibers may comprise at least one fiber core which is surrounded by at least one fiber cladding. The fiber cladding may have a lower index of refraction as the fiber core. The fiber cladding may also be a double or multiple cladding. The fiber cladding may comprise a so-called outer jacket. The fiber cladding may be coated by a so-called buffer adapted to protect the optical receiving fiber from damages and moisture. The buffer may comprise at least one UV-cured urethane acrylate composite and/or at least one polyimide material. In one embodiment, a refractive index of the fiber core may be higher than the refractive index of the fiber cladding material and the optical receiving fiber may be adapted to guide the incoming light beam by total internal reflection below the angle of acceptance. In one embodiment, the optical receiving fibers may comprise at least one hollow core fiber, also called photonic bandgap fiber. The hollow-core fiber may be adapted to guide the incoming light beam essentially within a so-called hollow region, wherein a minor portion of the light beam is lost due to propagation into the fiber cladding material.

The optical receiving fibers may comprise one or more fiber connectors at the end of the respective optical receiving fiber. The optical receiving fibers may comprise end caps such as coreless end caps. The optical receiving fibers may comprise one or more of a fiber coupler, a fiber Bragg grating, a fiber polarizer, a fiber amplifier, a fiber coupled diode laser, a fiber collimator, a fiber joint, a fiber splicing, a fiber connector, a mechanical splicing, a fusion splicing, or the like. The optical receiving fibers may comprise a polymer coating.

The optical receiving fibers may comprise at least two or more fibers. At least one of the optical receiving fibers may be at least one multifurcated optical fiber, in particular at least one bifurcated optical fiber. For example, the bifurcated optical fiber may comprise two fibers, in particular at least one first fiber and at least one second fiber. The first fiber and the second fiber may be arranged close to each other at an entrance end of the bifurcated optical fiber and may split into two legs separated by a distance at an exit end of the bifurcated optical fiber. The first and second fiber may be designed as fibers having identical properties or may be fibers of different type. The first fiber may be adapted to generate at least one first transmission light beam and the second fiber may be adapted to generate at least one second transmission light beam. The bifurcated optical fiber may be arranged such that the incident light beam may impinge at a first angle of incidence into the first fiber and at a second angle of incidence, different from the first angle, into the second fiber, such that the degree of transmission is different for the first transmission light beam and the second transmission light beam. At least one of the optical receiving fibers may comprise more than two fibers, for example three, four or more fibers. For example, the multifurcated may comprise multiple fibers wherein each fiber may comprise at least one of a core, a cladding, a buffer, a jacket, and one or more fibers may partially or entirely be bundled by a further jacket such as a polymer hose to ensure that the fibers stay close to each other such as at one end of the fiber. All optical receiving fibers may have the same numerical aperture. All optical receiving fibers may be arranged as such, that the light beam propagating from the object to the measurement head impinges on all of the optical receiving fibers between the transfer device and the focal point of the transfer device. The optical receiving fibers may be arranged as such, that the position along the optical axis where the light beam propagating from the object to the measurement head impinges on the optical receiving fibers is identical for all optical receiving fibers. Other arrangements may be possible.

The optical receiving fibers may have specific mechanical properties to ensure stability of the distance measurement in a broad range of environments. The mechanical properties of the optical receiving fibers may be identical, or the mechanical properties of the optical receiving fibers may differ. Without wishing to be bound by this theory, a the reliability of an optical system comprising optical receiving fibers for measuring in various and rapidly changing environmental conditions relies on relationships of refractive indices and certain energy transport properties.

Further certain mechanical parameters may be prerequisite that all functions of the optical system, including the optical receiving fibers, are maintained in a stable way, especially during a change of conditions. Therefore, certain mechanical parameters may act as prerequisite to ensure a stable measurement itself. At least one of the optical receiving fibers and/or the transfer device has a ratio εᵣ/k≥0.362 (m·K)/W. Preferably, at least one of the optical receiving fibers and/or the transfer device has the ratio εᵣ/k≥0.743 (m·K)/W, preferably the ratio is εᵣ/k≥1.133 (m·K)/W. At least one of the optical receiving fibers and/or the transfer device may have a ratio εᵣ/k in the range 0.362 (m·K)/W≤εᵣ/k≤1854 (m·K)/W, wherein k is the thermal conductivity and εᵣ is the relative permittivity. Without wishing to be bound by this theory in environments of rapid heat cycles and/or high temperatures or low temperatures associated with electrical heating devices and/or electrical cooling devices, associated with the electrical fields emitted by these devices and/or electrical spark devices and or heating arc devices, or the like, the use of optical systems within the given range for the quotient of thermal conductivity and the dielectric constant has shown to yield measurement heads with superior stability in these environments. The relative permittivity is also known as the dielectric constant. Preferably, the ratio εᵣ/k is in the range 0.743 (m·K)/W≤εᵣ/k≤194 (m·K)/W. More preferably, the ratio εᵣ/k is in the range 1.133 (m·K)/W≤εᵣ/k≤88.7 (m·K)/W. At least one of the optical receiving fibers and/or the transfer device may have a relative permittivity in the range 1.02≤εᵣ≤18.5, preferably in the range 1.02≤εᵣ≤14.5, more preferably in the range 1.02≤εᵣ≤8.7, wherein the relative permittivity is measured at 20° C. and 1 kHz. The optical receiving fibers and/or the transfer device may have a thermal conductivity of k≤24 (m·K)/W, preferably k≤17 (m·K)/W, more preferably k≤14 (m·K)/W. The optical receiving fibers and/or the transfer device may have a thermal conductivity of k≥0.003 (m·K)/W, preferably k≥0.007 (m·K)/W, more preferably k≥0.014 (m·K)/W. The thermal conductivity may be measured at 0° C. and <1% relative humidity.

The transfer device may have a ratio vₑ/n_{D} in the range 9.05≤vₑ/n_{D}≤77.3, wherein vₑ is the Abbé-number and n_{D} is the refractive index. The Abbé-number vₑ is given by

$${v}_{e} = \frac{( {n}_{D} - 1 )}{( {n}_{F} - {n}_{C} )} ,$$

wherein nᵢ is the refractive index for different wavelengths, wherein n_{C} is the refractive index for 656 nm, n_{D} is the refractive index for 589 nm and n_{F} is the refractive index for 486 nm, measured at room temperature, see e.g. https://en.wikipedia.org/wiki/Abbe_number. Preferably, the ratio vₑ/n_{D} is in the range of 13.9≤vₑ/n_{D}≤44.7, more preferably in the range of 15.8≤vₑ/n_{D}≤40.1. Without wishing to be bound by this theory, refractive indices always depend on manufacturing tolerances. Further, refractive indices are temperature dependent. Further, the wavelength of a light source always has a given tolerance concerning temperature variations. To ensure a stable distance measurement despite quickly changing or very high temperatures or uncontrolled surroundings, the Abbé-number to refractive index quotient may be limited to values that ensure the necessary stability range.

As outlined above, each of the optical receiving fibers may comprise the at least one cladding and the at least one core. A product αΔn may be αΔn≤110 dB/km at at least one wavelength in a visual and near infrared wavelength range, preferably at at least one wavelength selected from 656 nm, 589 nm, or 486 nm, wherein a is the attenuation coefficient and Δn is the refractive index contrast with Δn=(n₁²−n₂²)/(2n₁²), wherein n₁ is the maximum core refractive index and n₂ is the cladding refractive index. Preferably, the product αΔn is αΔn≤23 dB/km, preferably αΔn≤11.26 dB/km. The product αΔn may be in the range 0.0004 dB/km≤αΔn≤5110 dB/km at at least one wavelength in a visual and near infrared wavelength range, preferably at at least one wavelength selected from 656 nm, 589 nm, or 486 nm. Preferably, the product αΔn is in the range 0.002 dB/km≤αΔn≤23 dB/km, more preferably in the range 0.02 dB/km≤αΔn≤11.26 dB/km. The refractive index contrast Δn may be in the range 0.0015≤Δn≤0.285, preferably in the range 0.002≤Δn≤0.2750, more preferably in the range 0.003≤Δn≤0.25. The attenuation coefficient of the optical receiving fiber may be in the range 0.2 dB/km≤α≤420 dB/km, preferably in the range 0.25 dB/km≤α≤320 dB/km. The transfer device may have an aperture area D₁ and at least one of the optical receiving fibers may be a fiber core with a cross-sectional area D₂, wherein a ratio D₁/D₂ is in the range 0.54≤D₁/D₂≤5087, preferably 1.27≤D₁/D₂≤413, more preferably 2.17≤D₁/D₂≤59.2. Without wishing to be bound by this theory, limiting the mechanical boundaries of the optical system may result in a strongly improved the measurement stability concerning the optical system. A diameter d_{core} of the core of at least one of the optical receiving fibers may be in the range 2.5 μm≤d_{core}≤10000 μm, preferably in the range 7 μm≤d_{core}≤3000 μm, more preferably in the range 10 μm≤d_{core}≤500 μm. Without wishing to be bound by this theory, the refractive index contrast of optical receiving fibers has shown to be sensitive concerning manufacturing tolerances and/or manufacturing quality while again it is sensitive concerning temperature changes and/or high temperatures. Further, the attenuation coefficient without being related to the refractive index contrast and being mainly influenced by material properties shows a comparable sensitivity to manufacturing quality, temperature changes, high operating temperatures, or the like. Further, the concerned sensitivity of these quantities needs to be limited to a certain range to ensure a proper functioning of the measurement head, if a strong independence of environmental parameters is required.

The optical receiving fibers and/or the transfer device may have a Youngs modulus, also denoted elastic modulus, of less or equal 188 GPa, measured at room temperature, for example by using ultrasonic testing. Preferably the optical receiving fibers and/or the transfer device may have a Youngs modulus of less or equal 167 GPa, more preferably in the range from to 0.0001 GPa to 97 GPa. The optical receiving fibers and/or the transfer device may have a Youngs modulus of greater or equal 0.0001 GPa, preferably of greater or equal 0.007 GPa, more preferably of greater or equal 0.053 GPa.

As outline above, each of the optical receiving fibers may have at least one entrance face. A geometric center of the respective entrance face may be aligned perpendicular with respect to an optical axis of the transfer device. As used herein, the term “geometrical center” of an area generally may refer to a center of gravity of the area. As an example, if an arbitrary point inside or outside the area is chosen, and if an integral is formed over the vectors interconnecting this arbitrary point with each and every point of the area, the integral is a function of the position of the arbitrary point. When the arbitrary point is located in the geometrical center of the area, the integral of the absolute value of the integral is minimized. Thus, in other words, the geometrical center may be a point inside or outside the area with a minimum overall or sum distance from all points of the area.

At least one of the optical receiving fibers may have an entrance face which is oriented towards the object. As used herein, the term “is oriented towards the object” generally refers to the situation that the respective surfaces or openings of the entrance faces are fully or partially visible from the object. Specifically, at least one interconnecting line between at least one point of the object and at least one point of the respective entrance face may form an angle with a surface element of the entrance face which is different from 0°, such as an angle in the range of 20° to 90°, preferably 80 to 90° such as 90°. Thus, when the object is located on the optical axis or close to the optical axis, the light beam propagating from the object towards the measurement head may be essentially parallel to the optical axis. As used herein, the term “essentially perpendicular” refers to the condition of a perpendicular orientation, with a tolerance of e.g. ±20° or less, preferably a tolerance of ±100 or less, more preferably a tolerance of ±5° or less. Similarly, the term “essentially parallel” refers to the condition of a parallel orientation, with a tolerance of e.g. ±20° or less, preferably a tolerance of ±10° or less, more preferably a tolerance of ±5° or less. Additionally or alternatively, at least one of the entrance faces may be oriented differing from an orientation towards the object. For example, at least one of the entrance faces may be oriented perpendicular or under an arbitrary angle to the optical axis and with respect to the object.

The transfer device may be adapted to adjust and/or to change the direction of propagation of the light beam. The transfer device, in particular, may be or may comprise at least one GRIN lens and/or at least one diffractive optical element (DOE). The transfer device may be adapted to influence, for example to divert, the light beam propagating from the object to the measurement head. In particular, the transfer device may be adapted to adjust the direction of propagation of the light beam. The transfer device may be adapted to adjust and/or to generate an angle of propagation with respect to the optical axis of the transfer device. The angle of propagation may be an angle between the optical axis of the transfer device and the direction of propagation of the light beam propagating from the object to the measurement head. Without using a transfer device, the angle of propagation of the light beam may depend primarily on properties of the object, such as surface properties and/or material properties, from which the light beam was generated. The transfer device may be adapted to adjust and/or to generate the angle of propagation such that it is independent from surface properties of the object. The transfer device may be adapted to strengthen and/or to amplify angle dependency of the direction of propagation of the light beam. Without wishing to be bound by theory, the light beam generated by the object may propagate from the object to the measurement head and may impinge on the transfer device under an angle range from 0°, i.e. the optical axis, to an arbitrary angle X, which may be defined by an origin of the scattering on the object to an edge of the transfer device. Since the transfer device may comprise focusing properties, the angle range after passing through the transfer device may differ significantly from the original angle range. For example, light beams impinging parallel to the optical axis may be focused on the focal point or focus. Depending on focusing properties of the transfer device the angle dependency before impinging on the transfer device and after passing through the transfer device may be inverted. The transfer device may be adapted to amplify the angle dependency for a far field, i.e. in case the object is arranged at far distances, wherein light beams are propagating essentially parallel to the optical axis. Generally, without using the transfer device the angle dependency may be greatest in near field regions. In the near field, signals may generally be stronger compared to far field signals. Therefore, a smaller angle dependency in the near field due to a transfer device that amplifies the angle dependency in the far field, may be at least partially compensated by a generally better signal to noise ratio in the near field, and/or by using additional near field properties such as a distance dependent spot-movement due to a non-zero baseline. Additionally or alternatively, for adjusting and/or changing the direction of propagation of the light beam at least one of the optical receiving fibers may be a structured fiber having a shaped and/or structured entrance and/or exit face. Using a structured fiber may allow further increasing the angle dependency of the incoming light beam.

The optical receiving fibers may be arranged in a direction of propagation of the incident light beam propagating from the object to the measurement head behind the transfer device. The optical receiving fibers and the transfer device may be arranged such that the light beam propagating from the object to the measurement head passes through the transfer device before impinging on the optical receiving fibers. The transfer device such as a GRIN lens and the optical receiving fibers may be configured as one-piece. The optical receiving fibers may be attached to the transfer device such as by a polymer or glue or the like, to reduce reflections at interfaces with larger differences in refractive index. Alternatively, the transfer device and the optical receiving fibers may be arranged spatially separated such as separated in a direction in or parallel to the optical axis. The transfer device and/or the optical receiving fibers may be arranged displaced in a direction perpendicular to the optical axis. The optical receiving fibers may be arranged as such, that the light beam propagating from the object to the measurement head impinges on the optical receiving fibers between the transfer device and the focal point of the transfer device. For example, a distance in a direction parallel to the optical axis between the transfer device and the position where the light beam propagating from the object to the measurement head impinges on the optical receiving fibers may be at least 20% of the focal length, more preferably at least 50% of the focal length, most preferably at least 80% of the focal length. For example, the distance in a direction parallel to the optical axis between the entrance face at least one of the optical receiving fibers receiving the light beam propagating from the object to the measurement head and the transfer device may be at least 20% of the focal length, more preferably at least 50% of the focal length, most preferably at least 80% of the focal length.

Each of the optical receiving fibers may be configured to generate the at least one light beam having at least one beam profile depending on the angle of incidence of the incident light beam propagating from the object towards the measurement head and impinging on the respective optical receiving fiber. In particular, each of the optical receiving fibers may be adapted to influence and/or change and/or adjust the beam profile of the incident light beam. For example, each of the optical elements may have one or more of angle dependent transmission properties, angle dependent reflection properties or angle dependent absorption properties. The light beam having passed through the respective optical receiving fiber may comprise at least one transmission light beam and/or at least one reflection light beam. The angle of incidence may be measured with respect to an optical axis of the optical receiving fiber such as of the entrance face.

An electromagnetic wave impinging on the entrance face may be partly, depending on the properties of the optical receiving fiber absorbed and/or reflected and/or transmitted. The term “absorption” refers to a reduction of power and/or intensity of the incident light beam by the optical receiving fiber. For example, the power and/or intensity of the incident light beam may be transformed by the optical receiving fiber to heat or another type of energy. As used herein, the term “transmission” refers to a part of the electromagnetic wave which is measurable outside the optical receiving fiber in a half-space with angles from 90° and higher with respect to the optical axis. For example, transmission may be a remaining part of the electromagnetic wave impinging on the entrance face, passing through the optical receiving fiber and leaving the optical receiving fiber at the exit end. The term “reflection” refers to a part of the electromagnetic wave which is measurable outside the optical receiving fiber in a half-space with angles below 90° with respect to the optical axis. For example, reflection may be a change in direction of a wavefront of the incident light beam due to interaction with the optical receiving fiber. The total power of the electromagnetic wave impinging on the optical receiving fiber may be distributed by the optical receiving fiber in at least three components, i.e. an absorption component, a reflection component and a transmission component. A degree of transmission may be defined as power of the transmission component normalized by the total power of the electromagnetic wave impinging on the optical receiving fiber. A degree of absorption may be defined as power of the absorption component normalized by the total power of the electromagnetic wave impinging on the optical receiving fiber. A degree of reflection may be defined as power of the reflection component normalized by the total power of the electromagnetic wave impinging on the optical receiving fiber. Use of at least one transfer device allows to further enhance robustness of the measurement of the longitudinal coordinate. The transfer device may, for example, comprise at least one collimating lens. The optical receiving fibers may be designed to weaken rays impinging with larger angles compared to rays impinging with a smaller angle. For example, the degree of transmission may be highest for light rays parallel to the optical axis, i.e. at 0°, and may decrease for higher angles. In particular, at at least one cut-off angle the degree of transmission may steeply fall to zero. Thus, light rays having a large angle of incidence may be cut-off.

The measurement head may comprise a plurality of optical receiving fibers, for example a plurality of single optical receiving fibers or a plurality of multifurcated optical receiving fibers. For example, the optical receiving fibers may be arranged in a bundle of optical receiving fibers. For example, the measurement head may comprise a plurality of single optical fibers, for example optical receiving fibers having identical properties. The optical fibers, i.e. the single optical fibers or multifurcated optical fibers, may be arranged such that the incident light beam may impinge at different angles of incidence into each of the optical fibers such that the degree of transmission is different for each of the optical fibers.

The measurement head may comprise at least one spacer device. The spacer device may be configured for connecting the at least one transfer device and at least one of the optical fibers. The spacer device may be configured to attach the transfer device to at least one of the optical fibers. In case the measurement head comprises a plurality of transfer devices and/or optical fibers, the spacer device may be configured for connecting at least one of the transfer devices with at least one of the optical fibers. Optical paths of the optical fibers may be fully or partially optically separated by mechanical means such as a fully or partially intransparent mechanical wall or cladding or the like to avoid internal reflections. This optical separation by mechanical means may be part of the spacer device. The spacer device may comprise a solid volume Vₛ and a hollow volume Vₕ, also denoted hull volume. The solid volume may be defined by the volume of solid material of which the spacer device consists of. The hull volume may be a convex hull volume. The convex hull volume of the spacer device may be defined as the volume of the smallest convex hull of the solid volume of the spacer device. The hollow volume of the spacer device may be defined as the convex hull volume of the spacer device minus the solid volume of the spacer device. For example, the empty volume may be defined by inner edges of the solid material. A ratio of solid volume and hollow volume Vₛ/Vₕ may be in the range 0.013≤Vₛ/Vₕ≤547, preferably in the range 0.047≤Vₛ/Vₕ≤87.6, more preferably in the range 0.171≤Vₛ/Vₕ≤26.2.

The incident light beam may propagate from the object towards the measurement head. As will be outlined in further detail below, the incident light beam may originate from the object, such as by the object and/or at least one illumination source integrated or attached to the object emitting the light beam, or may originate from a different illumination source, such as from an illumination source directly or indirectly illuminating the object, wherein the light beam is reflected or scattered by the object and, thereby, is at least partially directed towards the measurement head. The illumination source, as an example, may be or may comprise one or more of an external illumination source, an illumination source integrated into the detector or an illumination source integrated into a beacon device being one or more of attached to the object, integrated into the object or held by the object. Thus, the measurement head may be used in active and/or passive illumination scenarios.

The measurement head may further comprise an illumination source for illuminating the object. The illumination source may be configured for illuminating the object, for example, by directing a light beam towards the object, which reflects the light beam. The illumination source may be configured for generating an illuminating light beam for illuminating the object. Therefore, the illumination source may comprise at least one light source. Specifically, the illumination source may comprise at least one laser and/or laser source. The light source may be or may comprise at least one multiple beam light source. For example, the light source may comprise at least one laser source and one or more diffractive optical elements (DOEs). The illumination source may be adapted to illuminate the object through at least one angle-dependent optical element. Various types of lasers may be employed, such as semiconductor lasers. Additionally or alternatively, non-laser light sources may be used, such as LEDs and/or light bulbs. The illumination source may be adapted to generate and/or to project a cloud of points, for example the illumination source may comprise one or more of at least one digital light processing projector, at least one LCoS projector, at least one spatial light modulator; at least one diffractive optical element; at least one array of light emitting diodes; at least one array of laser light sources. The illumination source may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the illumination source may have a wavelength of 300 to 1000 nm, especially 500 to 1000 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1000 nm may be used. On account of their generally defined beam profiles and other properties of handleability, the use of at least one laser source as the illumination source is particularly preferred. The illumination source may be integrated into the spacer device of the measurement head.

The illumination source may be configured such that the illuminating light beam propagates from the detector towards the object along an optical axis of the measurement head. For this purpose, the measurement head may comprise at least one reflective element, preferably at least one prism, for deflecting the illuminating light beam onto the optical axis.

The illumination source may comprise at least one optical illumination fiber. The optical illumination fiber may have at least one entrance end. The at least one light source may be positioned at the entrance end. The illumination source may comprise at least one coupling element configured to couple at least one light beam generated by the light source into the optical illumination fiber. The optical illumination fiber may further comprise at least one exit end, wherein the exit end is configured to emit the light beam having passed through the optical illumination fiber. The illumination source may comprise at least one further transfer device. The further transfer device may be designed as one-piece with the transfer device, e.g. the transfer device may be used as further transfer device.

Further, the illumination source may be configured for emitting modulated or non-modulated light. In case a plurality of illumination sources is used, the different illumination sources may have different modulation frequencies which later on may be used for distinguishing the light beams.

The illuminating light beam generally may be parallel to the optical axis of the measurement head, specifically of the transfer device, or tilted with respect to the optical axis, e.g. including an angle with the optical axis. As an example, the illuminating light beam, such as the laser light beam, and the optical axis may include an angle of less than 10°, preferably less than 5° or even less than 2°. Other embodiments, however, are feasible. Further, the illuminating light beam may be on the optical axis or off the optical axis. As an example, the illuminating light beam may be parallel to the optical axis having a distance of less than 10 mm to the optical axis, preferably less than 5 mm to the optical axis or even less than 1 mm to the optical axis or may even coincide with the optical axis.

The measurement head may comprise a further coupling element, in particular a further in-coupling element, adapted to couple the light beam travelling from the object to the measurement head into the optical fibers. The further coupling element may be arranged in direction of propagation of the light beam travelling from the object to the detector in front of the optical fibers. The further coupling element may be or may comprise at least one transfer device.

The measurement head may comprise one illumination source or a plurality of identical illumination sources and/or a plurality of different illumination sources. For example, the plurality of illumination sources may comprise at least two illumination sources generating light with different properties such as color or modulation frequencies.

The illumination source may have a geometrical extend G in the range 1.5·10⁻⁷ mm²·sr G≤314 mm²·sr, preferable in the range 1·10⁵ mm²·sr≤G≤22 mm²·sr, more preferable in the range 3·10⁻⁴ mm²·sr≤G≤3.3 mm²·sr. The geometrical extent G of the illumination source may be defined by

G=A·Ω·n²,

wherein A is the area of the surface, which can be an active emitting surface, a light valve, optical aperture or the area of the fiber core with A=A_{OF}=π·r²_{OF}, and Ω is the projected solid angle subtended by the light and n is the refractive index of the medium. For rotationally-symmetric optical systems with a half aperture angle θ, the geometrical extend is given by

G=π·A·sin²(θ)n².

For optical fibers a divergence angle is obtained by θₘₐₓ=arcsin(NA/n), where NA is the maximum numerical aperture of the optical fiber.

The half aperture angle θ and/or the divergence angle θₘₐₓ may be small. In particular, the half aperture angle θ may be in the range 0.01°≤θ≤42°; preferably in the range of 0.1°≤θ≤21°; more preferably in the range of 0.15°≤θ≤13° and/or the divergence angle θₘₐₓ be in the range 0.01°≤θₘₐₓ≤42°; preferably in the range of 0.1°≤θₘₐₓ≤21°; more preferably in the range of 0.15°≤θₘₐₓ≤13°. The area A may be small. In particular, the area A may be smaller than 10 mm², preferably smaller than 3 mm², more preferably smaller than 1 mm².

The measurement head may comprise a small baseline. In particular, the baseline may be a distance between at least one illumination channel and at least one receiver channel of the detector. Specifically, a distance, for example in a xy-plane, between at least one illumination channel and at least one receiver channel may be as small as possible. As used herein, the term “illumination channel” refers to at least one optical channel comprising at least one illumination source such as at least one optical illumination fiber adapted to generate at least one illumination light beam for illuminating the at least one object. The illumination channel may comprise at least one transmitter-optics such as at least one illumination source and at least one lens element. As used herein, the term “receiver channel” refers to at least one optical channel comprising at least one of the optical receiving fibers adapted to receive the light beam propagating from the object to the measurement head. The receiver channel may comprise at least one receiver-optics such as the at least one transfer device. The baseline, i.e. the distance between the illumination channel and the receiver channel, may be a minimum distance. The minimum distance may depend only on a size of components of the transmitter-optics and the receiver-optics. The minimum distance may be zero. In particular, a distance perpendicular to an optical axis of the measurement head between the illumination source and the entrance face of the optical receiving fibers may be small. Each optical receiving fiber comprises the at least one fiber cladding and the at least one core. A ratio d₁/BL may be in the range 0.0011≤d₁/BL≤513, where d₁ is the diameter of the core and BL is the baseline. Preferably, the ratio d₁/BL is in the range 0.0129≤d₁/BL≤28, more preferable in the range 0.185≤d₁/BL≤ and 7.1. The baseline may have an extent greater than 0. The baseline may be in the range 10 μm≤BL≤127000 μm, preferably in the range 100 μm≤BL≤76200 μm, more preferably in the range 500 μm≤BL≤25400 μm. As used herein, the term “baseline”, also denoted as basis line, further refers to a distance, for example in a xy-plane, between at least one transmitter-optics and at least one receiver-optics. For example, the baseline may be a distance between the optical axis and the illumination source, in particular a distance between the optical axis and a z-component of the illumination light beam. The measurement head may comprise additional optical elements, for example, at least one mirror, which may additionally enhance distance to the illumination source. For example, the baseline may be a distance between a transmitter-lens and a receiver-lens. The transmitter-lens may be arranged behind the optical illumination fiber in direction of propagation of the illumination light beam. The receiver-lens may be arranged in front of the optical receiving fiber, also denoted as measurement fiber, in a direction of propagation of the light beam propagating from the object to the measurement fiber. The transfer device may comprise the receiver-lens. Specifically, the term “baseline” refers to a distance between the position where the light beam propagating from the object to the measurement head impinges on the optical receiving fibers, in particular at least one entrance face or end of the at least one receiving fiber, and the illumination source and/or at least one exit face or end of at least one optical illumination fiber. As used herein, the term “entrance face or end of the optical illumination fiber” refers to at least one end of the optical illumination fiber which is adapted to receive the light beam generated by the light source. The term “exit face or end of the optical illumination fiber” refers to at least one end of the optical illumination fiber from which the light beam propagating through the optical illumination fiber leaves the optical illumination fiber. As used herein, the term “entrance face or end of the optical receiving fiber” refers to at least one end of the optical receiving fiber which is adapted to receive the light beam propagating from the object to the measurement head. The term “exit face of the optical receiving fiber” refers to at least one end of the optical receiving fiber from which the light beam propagating through the optical receiving fiber leaves the optical receiving fiber. The optical receiving fibers may comprise two receiving fibers, a first optical receiving fiber providing light to a first optical sensor and a second optical receiving fiber providing light to a second optical sensor. Each of the optical receiving fibers may comprise an exit end and an entrance end. For example, the optical receiving fibers may comprise at least two optical receiving fibers each having at least one entrance face, wherein the entrance faces may be arranged concentric or on top of each other or parallel to each other or side by side.

The illumination source may be adapted to generate at least one illumination light beam, wherein the optical illumination fiber may be attached to the further transfer device such as by a polymer or glue or the like, to reduce reflections at interfaces with larger differences in refractive index. For example, the measurement head may be a compact device without further optical elements, wherein the illumination source may be placed as close as possible to an edge of the transfer device. Thus, the baseline may be close to half a diameter of the transfer device, in particular the lens diameter and housings of lens and light source. For example, the measurement head may be an even more compact device, wherein a mirror, in particular a small mirror, may be positioned in front of the transfer device, in particular in a center, for example a geometrical center, or close to the center of the transfer device, in order to couple the illumination beam into the beam path. Thus, the baseline may be less than half the diameter of the transfer device. The illumination source may be arranged such that the baseline is as small as possible. By arranging the illumination source and/or the exit face of the illumination fiber such that the direction of propagation of the illumination light beam is essentially parallel to the optical axis and that the illumination source and/or the exit face of the illumination fiber and the optical axis are separated by the small baseline, very compact devices are possible. For example, a distance from the center of the transfer device to the illumination source and/or the exit face of the illumination fiber, in particular along a connecting line from the center of the transfer device to the illumination source and/or the exit face of the illumination fiber, may be preferably less than 2.5 times a distance from the center of the transfer device to an edge of the transfer device, more preferably less than 1.5 times the distance center to edge of the transfer device, and most preferably less 1 times the distance center to edge of the transfer device. The transfer device may have an arbitrary shape, in particular non-circular shapes are possible. At small distances an aperture of the illumination source may be small and the baseline may be small. At large distances an aperture of the illumination source may be large and the baseline may be small. This is contrarily as in triangulation methods, wherein at large distances a large baseline is necessary. Further, triangulation-based systems have a minimum detection range significantly greater than zero, for example such as 20 cm from the detector system, due to necessary spatial extent of the baseline. Such a large baseline may result in that the illuminated light scattered from the object may not reach the light-sensitive area of the optical sensor behind the transfer device. In addition, in triangulation-based systems, using a small baseline would reduce the minimum detection range, however, at the same time would reduce a maximum detection range. Further, triangulation-based systems require a plurality of light-sensitive areas and sensor signals, for example sensor signals of at least one detector row. According to the invention, determination of the longitudinal coordinate z is possible with a reduced number of sensor signals, in particular with less than 20, preferably less than 10 and more preferably less than 5 sensor signals. The illumination source and the optical receiving fibers may be arranged in the direction of propagation of the light beam traveling from the object to the measurement head behind the transfer device, which will be described in detail below. The distance perpendicular to the optical axis of the measurement head between the illumination source such as the exit face of the illumination fiber and the entrance face of the optical receiving fibers may be less than the radius of the transfer device.

The measurement head may comprise at least one actuator configured to move the measurement head to scan a region of interest. As used herein, the term “move” refers to driving the measurement head and/or to causing the measurement head to oscillate. As used herein, the term “actuator” refers to an arbitrary device adapted to generate a force causing the measurement head to move. Specifically, the actuator may be attached and/or coupled and/or connected to the optical receiving fibers and may be adapted to generate a force causing the optical receiving fibers to move, in particular to oscillate. The actuator may be attached and/or coupled and/or connected to the optical illumination fiber and may be adapted to generate a force causing the optical illumination fiber to move. The actuator may be adapted to generate a force corresponding to a harmonic of a natural resonant frequency of the optical receiving fibers and/or the optical illumination fiber. The actuator may comprise at least one electromechanical actuator and/or at least one piezo actuator. The piezo actuator may comprise at least one actuator selected from the group consisting of: at least one piezoceramic actuator; at least one piezoelectric actuator. The actuator may be configured to cause the measurement head, specifically the optical illumination fiber and/or the optical receiving fibers to oscillate. The actuator may be adapted to move the measurement head in a linear scan and/or a radial scan and/or a spiral scan. For example, the actuator may be adapted to generate a force on the measurement head such that the measurement head moves upwards and downwards. For example, the actuator may be configured to generate a force on the measurement head such that the measurement head moves in an orbit with a predefined radius. The radius may be adjustable. For example, the actuator may be adapted to generate a force such that the measurement head moves in a spiral such as with a radius which alternately decreases or increases.

In a further aspect of the present invention, a kit for determining a position of at least one object is disclosed. The kit comprises at least one measurement head according to the embodiments disclosed above and/or according to one or more of the embodiments disclosed in further detail below. The kit further comprises at least one detector comprising
at least two optical sensors, wherein each optical sensor has at least one light-sensitive area, wherein each optical sensor is designed to generate at least one sensor signal in response to an illumination of its respective light-sensitive area by a light beam having passed through at least one of the optical receiving fibers of the measurement head;
at least one evaluation device being configured for determining at least one longitudinal coordinate z of the object by evaluating a combined signal Q from the sensor signals.

As used herein, an “optical sensor” generally refers to a light-sensitive device for detecting a light beam, such as for detecting an illumination and/or a light spot generated by at least one light beam. As further used herein, a “light-sensitive area” generally refers to an area of the optical sensor which may be illuminated externally, by the at least one light beam, in response to which illumination the at least one sensor signal is generated. The light-sensitive area may specifically be located on a surface of the respective optical sensor. Other embodiments, however, are feasible. As used herein, the term “at least two optical sensors each having at least one light sensitive area” refers to configurations with two single optical sensors each having one light-sensitive area and to configurations with one combined optical sensor having at least two light-sensitive areas. Thus, the term “optical sensor” furthermore refers to a light-sensitive device configured to generate one output signal, whereas, herein, a light-sensitive device configured to generate two or more output signals, for example at least one CCD and/or CMOS device, is referred to as two or more optical sensors. As will further be outlined in detail below, each optical sensor may be embodied such that precisely one light-sensitive area is present in the respective optical sensor, such as by providing precisely one light-sensitive area which may be illuminated, in response to which illumination precisely one uniform sensor signal is created for the whole optical sensor. Thus, each optical sensor may be a single area optical sensor. The use of the single area optical sensors, however, renders the setup of the detector specifically simple and efficient. Thus, as an example, commercially available photo-sensors, such as commercially available silicon photodiodes, each having precisely one sensitive area, may be used in the set-up. Other embodiments, however, are feasible. Thus, as an example, an optical device comprising two, three, four or more than four light-sensitive areas may be used which is regarded as two, three, four or more than four optical sensors in the context of the present invention. As an example, the optical device may comprise a matrix of light-sensitive areas. Thus, as an example, the optical sensors may be part of or constitute a pixelated optical device. As an example, the optical sensors may be part of or constitute at least one CCD and/or CMOS device having a matrix of pixels, each pixel forming a light-sensitive area.

Each of the optical receiving fibers may be configured to emit the at least one light beam such that the light beam impinges on the light-sensitive areas. For example, in case at least one of the light-sensitive areas is oriented under the arbitrary angle with respect to the optical axis, the optical receiving fibers may be adapted to guide the light beam onto the light-sensitive area.

As further used herein, a “sensor signal” generally refers to a signal generated by an optical sensor in response to the illumination by the light beam. Specifically, the sensor signal may be or may comprise at least one electrical signal, such as at least one analogue electrical signal and/or at least one digital electrical signal. More specifically, the sensor signal may be or may comprise at least one voltage signal and/or at least one current signal. More specifically, the sensor signal may comprise at least one photocurrent. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like.

The optical sensors may be sensitive in one or more of the ultraviolet, the visible or the infrared spectral range. Specifically, the optical sensors may be sensitive in the visible spectral range from 500 nm to 780 nm, most preferably at 650 nm to 750 nm or at 690 nm to 700 nm. Specifically, the optical sensors may be sensitive in the near infrared region. Specifically, the optical sensors may be sensitive in the part of the near infrared region where silicon photodiodes are applicable specifically in the range of 700 nm to 1000 nm. The optical sensors, specifically, may be sensitive in the infrared spectral range, specifically in the range of 780 nm to 3.0 micrometers. For example, the optical sensors each, independently, may be or may comprise at least one element selected from the group consisting of a photodiode, a photocell, a photoconductor, a phototransistor or any combination thereof. For example, the optical sensors may be or may comprise at least one element selected from the group consisting of a CCD sensor element, a CMOS sensor element, a photodiode, a photocell, a photoconductor, a phototransistor or any combination thereof. Any other type of photosensitive element may be used. As will be outlined in further detail below, the photosensitive element generally may fully or partially be made of inorganic materials and/or may fully or partially be made of organic materials. Most commonly, as will be outlined in further detail below, one or more photodiodes may be used, such as commercially available photodiodes, e.g. inorganic semiconductor photodiodes.

At least one optical sensor may be arranged at the exit ends of each optical receiving fiber. Alternatively, at least two or more of the optical receiving fibers may use the same optical sensor. The optical sensors at the end of the optical receiving fibers may be arranged as such that at least 80%, preferably at least 90%, more preferably at least 99% of the luminance power of the light beams exiting the optical receiving fiber towards the optical sensors impinge on at least one optical sensor. A position relative to the transfer device where the light beam travelling from the object to the measurement device impinges on the optical receiving fibers may be optimized to obtain a combined signal Q with a high dynamic range.

The illumination source and/or the exit face of the optical illumination fiber and the entrance face of one or both of the optical receiving fibers may be arranged with a relative spatial offset from the optical axis of the transfer device. In particular, the illumination source and/or the exit face of the illumination fiber and the entrance face of one or both of the optical receiving fibers may be arranged with different spatial offsets from the optical axis. Such an arrangement may allow enhancing the tendency of the combined signal Q, and thus, accuracy of the distance measurement. In particular, with increasing spatial offset a slope in a Q vs distance diagram increases and thus allows distinguishing similar distances more accurately. For example, one of the illumination source and the entrance face of one or both of the optical receiving fibers may be arranged on the optical axis and the other one may be arranged spaced apart from the optical axis. For example, both of illumination source and the entrance face of one or both of the optical receiving fibers may be arranged spaced apart from the optical axis by at least one different distance, in particular perpendicular to the optical axis. For example, the at least two optical receiving fibers may be arranged at different distances from the optical axis. The optical receiving fibers may be adapted to mimic a larger distance compared to the real distance perpendicular to an optical axis between the illumination source and the optical sensors without moving the illumination source and/or optical sensors.

The optical sensors and/or the entrance face of at least one of the optical receiving fibers may be positioned off focus. As used herein, the term “focus” generally refers to one or both of a minimum extent of a circle of confusion of the light beam, in particular of at least one light beam emitted from one point of the object, caused by the transfer device or a focal length of the transfer device. As used herein, the term “circle of confusion” refers to a light spot caused by a cone of light rays of the light beam focused by the transfer device. The circle of confusion may depend on a focal length f of the transfer device, a longitudinal distance from the object to the transfer device, a diameter of an exit pupil of the transfer device, a longitudinal distance from the transfer device to the light-sensitive area, a distance from the transfer device to an image of the object. For example, for Gaussian beams, a diameter of the circle of confusion may be a width of the Gaussian beam. In particular, for a point like object situated or placed at infinite distance from the detector the transfer device may be adapted to focus the light beam from the object into a focus point at the focal length of the transfer device. For non-point like objects situated or placed at infinite distance from the detector the transfer device may be adapted to focus the light beam from at least one point of the object into a focus plane at the focal length of the transfer device. For point like objects not situated or placed at infinite distance from the measurement head, the circle of confusion may have a minimum extent at least at one longitudinal coordinate. For non-point like objects not situated or placed at infinite distance from the measurement head, the circle of confusion of the light beam from at least one point of the object may have a minimum extent at least at one longitudinal coordinate. As used herein, the term “positioned off focus” generally refers to a position other than the minimum extent of a circle of confusion of the light beam caused by the transfer device or a focal length of the transfer device. In particular, the focal point or minimum extent of the circle of confusion may be at a longitudinal coordinate I_{focus}, whereas the position of each of the optical sensors and/or the entrance face of at least one of the optical receiving fibers may have a longitudinal coordinate Iₛₑₙₛₒᵣ different from I_{focus}. For example, the longitudinal coordinate Iₛₑₙₛₒᵣ may be, in a longitudinal direction, arranged closer to the position of the transfer device than the longitudinal coordinate I_{focus} or may be arranged further away from the position of the transfer device than the longitudinal coordinate I_{focus}. Thus, the longitudinal coordinate Iₛₑₙₛₒᵣ and the longitudinal coordinate I_{focus} may be situated at different distances from the transfer device. For example, the optical sensors and/or the entrance face of at least one of the optical receiving fibers may be spaced apart from the minimum extent of the circle of confusion in longitudinal direction by ±2% of focal length, preferably by ±10% of focal length, most preferably ±20% of focal length. For example, at a focal length of the transfer device may be 20 mm and the longitudinal coordinate Iₛₑₙₛₒᵣ may be 19.5 mm, i.e. the sensors and/or the entrance face of at least one of the optical receiving fibers may be positioned at 97.5% focal length, such that Iₛₑₙₛₒᵣ is spaced apart from the focus by 2.5% of focal length.

For example, the entrance face of at least one of the optical receiving fibers may be arranged such that the variance over distance dependence of the combined signal is maximal, which is equivalent to a maximum dynamic range in the combined signal Q. Without wishing to be bound by this theory, a practical approximation for maximizing the dynamic range is to maximize a circle of confusion variance over distance dependence. The quotient of circle of confusion radii at small and large object distances is a practical approximation to the quotient of combined signals at small and large object distances. In particular, the entrance face of at least one of the optical receiving fibers may be positioned as such that a combined signal Q_{far} at large object distances and a combined signal Q_{close} at small object distances have a maximum variation

$$\frac{{Q}_{far}}{{Q}_{close}} \approx \frac{{{r}_{CoC}^{Object , close} ( {z}_{o} , {z}_{s} , {z}_{i} )}^{2}}{{{r}_{CoC}^{Object , far} ( {z}_{o} , {z}_{s} , {z}_{i} )}^{2}} -> max ,$$

wherein r_{CoC}^{Object,close} is a radius of the circle of confusion at small object distances and r_{CoC}^{Object,far} is a radius of the circle of confusion at large object distances, wherein z_{O} is a detectable distance range between the entrance face of at least one of the optical receiving fibers and the object, zₛ is a distance between the transfer device and the entrance face of at least one of the optical receiving fibers and zᵢ is a position of the focused image behind the transfer device, which depends on the position of the object zₒ The optimal position of the optical receiving fibers, specifically the position of the end of the optical receiving fiber where the light beam travelling from the object to the measurement head impinges on the optical receiving fiber, may be adjusted using the following steps: i) positioning the entrance face of at least one of the optical receiving fibers at a focal point of farthest object distance; ii) moving the optical sensors and/or the entrance face of at least one of the optical receiving fibers out of the focal point, in particular along or against the optical axis, such that a distance Δ from the focal point gives the best circle of confusion variation and the largest range, wherein

$$Δ = \frac{{z}_{i}^{2} ( {z}_{o}^{far} )}{{z}_{o}^{far} f} {O}_{size} {F}_{♯} ,$$

wherein O_{size} is the spot size on the entrance face of at least one of the optical receiving fibers, f is the focal length of the transfer device, F_{#} is the F number of the transfer device, z_{O}^{far} is the farthest object distance.

As outlined above, the measurement head comprises at least two optical receiving fibers, in particular at least two receiving fibers, wherein a first receiving fiber is adapted to provide at least one part of the light beam propagating from the object to the measurement head to a first optical sensor and wherein a second receiving fiber is adapted to provide at least one part of the light beam propagating from the object to the measurement head to a second optical sensor. The measurement head may comprise a plurality of optical receiving fibers, wherein each of the optical receiving fibers is adapted to provide at least one part of the light beam propagating from the object to the measurement head to one of the optical sensors. Each geometrical center of the respective entrance face of the receiving fibers may be arranged at a longitudinal coordinate I_{center,i}, wherein i denotes the number of the respective receiving fiber. The detector may comprise precisely two optical sensors and/or the measurement head comprises precisely two receiving fibers, each comprising an entrance face. The detector may comprise more than two optical sensors and/or the measurement head comprises more than two receiving fibers. The receiving fibers may comprise at least one first receiving fiber having at least one first entrance face and at least one second receiving fiber having at least one second entrance face. The first entrance face, in particular the geometrical center, may be arranged at a first longitudinal coordinate I_{center,1}, and the second entrance face, in particular the geometrical center, may be arranged at a second longitudinal coordinate I_{center,2}, wherein the first longitudinal coordinate and the second longitudinal coordinate differ. For example, the first entrance end and the second entrance end may be located in different planes which are offset in a direction of the optical axis. The first entrance end may be arranged in front of the second entrance end. A relative distance of the first entrance end and the second entrance end may depend, for example, on focal length or object distance. The longitudinal coordinates of the entrance faces of the receiving fibers may also be identical. Specifically, the longitudinal coordinates of the entrance faces of the receiving fibers may be identical, but the entrance faces of the receiving fibers may be spaced apart from the optical axis by a different spatial offset. The first optical receiving fiber and the second optical receiving fiber may be arranged having a common central axis. The first optical receiving fiber and the second optical receiving fiber may be arranged concentric. The first optical receiving fiber may surround the second optical receiving fiber. For example, the first entrance face and the second entrance face may have a circular shape, wherein the first entrance face may be a circle with a first radius and the second entrance face may be circle with a second radius different from the first radius. Additionally or alternatively, the first entrance face may be spaced apart from the second entrance face. The first entrance face may be arranged in front of the second entrance face and may be spaced apart from the second entrance face by no more than 50 mm, preferably by no more than 15 mm. The relative distance of the first optical sensor and second optical sensor may depend, for example, on focal length or object distance.

Each geometrical center of each entrance face of the receiving fibers may be spaced apart from the optical axis of the transfer device, such as the optical axis of the beam path or the respective beam path in which the respective entrance face of the receiving fibers is located. In the case of the measurement head comprising precisely two receiving fibers each comprising one entrance face and in the case of the measurement head comprising more than two receiving fibers, the receiving fibers may comprise at least one first receiving fiber comprising at least one first entrance face being spaced apart from the optical axis by a first spatial offset and at least one second receiving fiber comprising at least one second entrance face being spaced apart from the optical axis by a second spatial offset, wherein the first spatial offset and the second spatial offset may differ. The first and second spatial offsets, as an example, may differ by at least a factor of 1.2, more preferably by at least a factor of 1.5, more preferably by at least a factor of 2. The spatial offsets may also be zero or may assume negative values if the longitudinal coordinates and/or a cross-section of the entrance faces of the receiving fibers may differ.

The optical receiving fibers may comprise at least one first receiving fiber having a first cross section and at least one second receiving fiber having a second cross section. The term “cross section” refers to an area perpendicular to a direction of extension of the receiving fiber. In the case of the measurement head comprising more than two receiving fibers, a first group of optical receiving fibers or at least one of the optical receiving fibers may form a first cross section, wherein a second group of optical receiving fibers or at least one other optical receiving fiber may form a second cross section. The first cross section and the second cross section may differ. In particular, the first cross section and the second cross section are not congruent. Thus, the cross section of the first receiving fiber and the second receiving fiber may differ in one or more of the shape or content. For example, the first cross section may be smaller than the second cross section. As an example, both the first cross section and the second cross section may have the shape of a circle. The radius of a first circle of the first entrance face may be smaller than the corresponding radius of a second circle of the second entrance face. Specifically, a diameter of the first cross section may be smaller than a diameter of the second cross section. Again, alternatively, as an example, the first cross section may have a first equivalent diameter, and the second cross section may have a second equivalent diameter, wherein the first equivalent diameter is smaller than the second equivalent diameter. The cross sections may be congruent, if the spatial offsets and/or the longitudinal coordinates of the entrance faces of the receiving fibers differ.

The evaluation device is configured for determining at least one longitudinal coordinate z of the object by evaluating a combined signal Q of the sensor signals. As generally used herein, the term “combine” generally may refer to an arbitrary operation in which two or more components such as signals are one or more of mathematically merged in order to form at least one merged combined signal and/or compared in order to form at least one comparison signal or comparison result. As used herein, the term “combined signal Q” refers to a signal which is generated by combining the sensor signals, in particular by one or more of dividing the sensor signals, dividing multiples of the sensor signals or dividing linear combinations of the sensor signals. In particular, the combined signal may be a quotient signal. The combined signal Q may be determined by using various means. As an example, a software means for deriving the combined signal, a hardware means for deriving the combined signal, or both, may be used and may be implemented in the evaluation device. Thus, the evaluation device, as an example, may comprise at least one divider, wherein the divider is configured for deriving the quotient signal. The divider may fully or partially be embodied as one or both of a software divider or a hardware divider.

The evaluation device may be configured for deriving the combined signal Q by one or more of dividing the sensor signals, dividing multiples of the sensor signals, dividing linear combinations of the sensor signals. The evaluation device may be configured for using at least one predetermined relationship between the combined signal Q and the longitudinal coordinate for determining the longitudinal coordinate. For example, the evaluation device is configured for deriving the combined signal Q by

$$Q ( {z}_{o} ) = \frac{{\int \int }_{{A}_{1}} E ( x , y \text{;} {z}_{o} ) dxdy}{{\int \int }_{{A}_{2}} E ( x , y \text{;} {z}_{o} ) dxdy}$$

wherein x and y are transversal coordinates, A1 and A2 are areas of the beam profile of the light beam having passed through the optical receiving fibers at the sensor position, and E(x,y,zₒ) denotes the beam profile given at the object distance zₒ. Area A1 and area A2 may differ. In particular, A1 and A2 are not congruent. Thus, A1 and A2 may differ in one or more of the shape or content. The beam profile may be a cross section of the light beam. The beam profile may be selected from the group consisting of a trapezoid beam profile; a triangle beam profile; a conical beam profile and a linear combination of Gaussian beam profiles. Generally the beam profile is dependent on luminance L(zₒ) and beam shape S(x,y;zₒ), E(x, y; zₒ)=L·S. Thus, by deriving the combined signal it may allow determining the longitudinal coordinate independent from luminance. In addition, using the combined signal allows determination of the distance z₀ independent from the object size. Thus, the combined signal allows determination of the distance z₀ independent from the material properties and/or reflective properties and/or scattering properties of the object and independent from alterations of the light source such as by manufacturing precision, heat, water, dirt, damages on the lens, or the like.

Each of the sensor signals may comprise at least one information of at least one area of the beam profile of the light beam having passed through the optical receiving fibers. As used herein, the term “area of the beam profile” generally refers to an arbitrary region of the beam profile at the sensor position used for determining the combined signal Q. The light-sensitive areas and/or the entrance faces of the optical receiving fibers may be arranged such that a first sensor signal comprises information of a first area of the beam profile and a second sensor signal comprises information of a second area of the beam profile. The first area of the beam profile and second area of the beam profile may be one or both of adjacent or overlapping regions. The first area of the beam profile and the second area of the beam profile may be not congruent in area.

The evaluation device may be configured to determine and/or to select the first area of the beam profile and the second area of the beam profile. The first area of the beam profile may comprise essentially edge information of the beam profile and the second area of the beam profile may comprise essentially center information of the beam profile. The beam profile may have a center, i.e. a maximum value of the beam profile and/or a center point of a plateau of the beam profile and/or a geometrical center of the light spot, and falling edges extending from the center. The second region may comprise inner regions of the cross section and the first region may comprise outer regions of the cross section. As used herein, the term “essentially center information” generally refers to a low proportion of edge information, i.e. proportion of the intensity distribution corresponding to edges, compared to a proportion of the center information, i.e. proportion of the intensity distribution corresponding to the center. Preferably the center information has a proportion of edge information of less than 10%, more preferably of less than 5%, most preferably the center information comprises no edge content. As used herein, the term “essentially edge information” generally refers to a low proportion of center information compared to a proportion of the edge information. The edge information may comprise information of the whole beam profile, in particular from center and edge regions. The edge information may have a proportion of center information of less than 10%, preferably of less than 5%, more preferably the edge information comprises no center content. At least one area of the beam profile may be determined and/or selected as second area of the beam profile if it is close or around the center and comprises essentially center information. At least one area of the beam profile may be determined and/or selected as first area of the beam profile if it comprises at least parts of the falling edges of the cross section. For example, the whole area of the cross section may be determined as first region. The first area of the beam profile may be area A2 and the second area of the beam profile may be area A1.

The edge information may comprise information relating to a number of photons in the first area of the beam profile and the center information may comprise information relating to a number of photons in the second area of the beam profile. The evaluation device may be adapted for determining an area integral of the beam profile. The evaluation device may be adapted to determine the edge information by integrating and/or summing of the first area. The evaluation device may be adapted to determine the center information by integrating and/or summing of the second area. For example, the beam profile may be a trapezoid beam profile and the evaluation device may be adapted to determine an integral of the trapezoid. Further, when trapezoid beam profiles may be assumed, the determination of edge and center signals may be replaced by equivalent evaluations making use of properties of the trapezoid beam profile such as determination of the slope and position of the edges and of the height of the central plateau and deriving edge and center signals by geometric considerations.

Additionally or alternatively, the evaluation device may be adapted to determine one or both of center information or edge information from at least one slice or cut of the light spot. This may be realized, for example, by replacing the area integrals in the combined signal Q by a line integral along the slice or cut. For improved accuracy, several slices or cuts through the light spot may be used and averaged. In case of an elliptical spot profile, averaging over several slices or cuts may result in an improved distance information.

The evaluation device may be configured to derive the combined signal Q by one or more of dividing the edge information and the center information, dividing multiples of the edge information and the center information, dividing linear combinations of the edge information and the center information. Thus, essentially, photon ratios may be used as the physical basis of the method.

As further used herein, the term “evaluation device” generally refers to an arbitrary device adapted to perform the named operations, preferably by using at least one data processing device and, more preferably, by using at least one processor and/or at least one application-specific integrated circuit. Thus, as an example, the at least one evaluation device may comprise at least one data processing device having a software code stored thereon comprising a number of computer commands. The evaluation device may provide one or more hardware elements for performing one or more of the named operations and/or may provide one or more processors with software running thereon for performing one or more of the named operations.

In an embodiment of the present invention, the detector may comprise:
at least one first optical sensor having a first light-sensitive area, wherein the first optical sensor may be configured to generate at least one first sensor signal in response to an illumination of the first light-sensitive area by the light beam having passed through one of the optical receiving fibers;
at least one second optical sensor having a second light-sensitive area, wherein the second optical sensor may be configured to generate at least one second sensor signal in response to an illumination of the second light-sensitive area by the light beam having passed through the other one of the optical receiving fibers.

The evaluation device may be configured for determining at least one longitudinal coordinate z of the object by evaluating the first and second sensor signals.

The entrance face of the optical receiving fibers may be identical in size and/or shape or may differ. For example, the first entrance face of a first optical receiving fiber may be smaller than the second entrance face of a second optical receiving fiber. The first entrance face may be smaller than the second light-sensitive area. As used therein, the term “is smaller than” refers to the fact that the surface area of the first entrance face is smaller than the surface area of the second entrance face, such as by at least a factor of 0.9, e.g. at least a factor of 0.7 or even by at least a factor of 0.5. As an example, both the first entrance face and the second entrance face may have the shape of a square or of a rectangle, wherein side lengths of the square or rectangle of the first entrance face are smaller than corresponding side lengths of the square or rectangle of the second entrance face. Alternatively, as an example, both the first entrance face and the second entrance face may have the shape of a circle, wherein a diameter of the first entrance face is smaller than a diameter of the second entrance face. Again, alternatively, as an example, the first entrance face may have a first equivalent diameter, and the second entrance face may have a second equivalent diameter, wherein the first equivalent diameter is smaller than the second equivalent diameter. The second entrance face may be larger than the first entrance face. Thus, as an example, the second entrance face may be larger by at least a factor of two, more preferably by at least a factor of three and most preferably by at least a factor of five than the first entrance face. The first entrance face specifically may be a small entrance face, such that, preferably, the light beam fully illuminates this entrance face. Thus, as an example which may be applicable to typical optical configurations, the first entrance face may have a surface area of 1 mm² to 150 mm², more preferably a surface area of 10 mm² to 100 mm². The entrance face specifically may be a large area. Thus, preferably, within a measurement range of the detector, light spots may fully be located within the second entrance face, such that the light spot is fully located within the borders of the second entrance face. As an example, which is applicable e.g. in typical optical setups, the second entrance face may have a surface area of 160 mm² to 1000 mm², more preferably a surface area of 200 mm² to 600 mm².

The first entrance face specifically may overlap with the second entrance face in a direction of propagation of the light beam. The light beam may illuminate both the first entrance face and, fully or partially, the second entrance face. Thus, as an example, as seen from an object located on an optical axis of the detector, the first entrance face may be located in front of the second entrance face, such that the first entrance face, as seen from the object, is fully located within the second entrance face. When the light beam from this object propagates towards the first and second entrance faces, the light beam may fully illuminate the first entrance face and may create a light spot on the second entrance face, wherein a shadow created by the first entrance face is located within the light spot. It shall be noted, however, that other embodiments are feasible.

The first and second entrance face specifically may be arranged linearly in one and the same beam path of the detector. As used herein, the term “linearly” generally refers to that the entrance face are arranged along one axis. Thus, as an example, the first and second entrance face both may be located on an optical axis of the detector. Specifically, the first and second entrance face may be arranged concentrically with respect to an optical axis of the detector.

The first entrance face may be arranged in front of the second entrance face. Thus, as an example, the first entrance face may simply be placed on the surface of the second entrance face. Additionally or alternatively, the first entrance face may be spaced apart from the second entrance face by no more than five times the square root of a surface area of the first entrance face. Additionally or alternatively, the first entrance face may be arranged in front of the second entrance face and may be spaced apart from the second entrance face by no more than 50 mm, preferably by no more than 15 mm.

In one example, the measurement head comprises
at least one first receiving fiber having a first cross section, wherein the first receiving fiber may be adapted to provide at least one part of the light beam propagating from the object to the measurement head to at least one optical sensor of the optical sensors;
at least one second receiving fiber having a second cross section, wherein the second receiving fiber may be adapted to provide at least one part of the light beam propagating from the object to the measurement head to at least one other optical sensor of the optical sensors.

The first cross section may be smaller than the second cross section.

The light beam propagating from the object to the measurement head specifically may fully illuminate the first cross section and/or the second cross section, such that the first cross section and/or the second cross section are fully located within the light beam, e.g. with a width of the light beam being larger than the first cross section of the first receiving fiber and/or the second cross section of the second receiving fiber. Contrarily, preferably, the light beam propagating from the object to the measurement head specifically may partially illuminate the first cross section and/or the second cross section. At least one or more appropriate lenses or elements having a focusing or defocusing effect on the light beam may be arranged in front of the entrance faces of the receiving fibers in direction of propagation of the light beam propagating from the object to the measurement head, for example an appropriate transfer device.

As outlined above, the first cross section may be smaller than the second cross section. As used therein, the term “is smaller than” refers to the fact that the first cross section is smaller than the second cross section, such as by at least a factor of 0.9, e.g. at least a factor of 0.7 or even by at least a factor of 0.5. As an example, both the first cross section and the second cross section may have the shape of a circle, wherein a diameter of the first cross section is smaller than a diameter of the second cross section. As outlined above, the second cross section may be larger than the first cross section. Thus, as an example, the second cross section may be larger by at least a factor of two, more preferably by at least a factor of three and most preferably by at least a factor of five than the first cross section.

The first cross section specifically may overlap with the second cross section in a direction of propagation of the light beam propagating from the object to the detector. The light beam propagating from the object to the detector may illuminate both the first cross section and, fully or partially, the second cross section. Thus, as an example, as seen from an object located on an optical axis of the detector, the first cross section may be located in a center of the second cross section such that the first cross section and the second cross section are concentric. It shall be noted, however, that other embodiments are feasible.

The entrance faces of the first and second receiving fibers specifically may be arranged at the same longitudinal coordinate or may be arranged at different longitudinal coordinates. Thus, as an example, the first and second entrance faces both may be located on an optical axis of the detector. Specifically, the first and second entrance faces may be arranged concentrically with respect to an optical axis of the detector. For example, the first entrance face may be arranged in front of the second entrance face. For example, the first entrance face may be spaced apart from the second entrance face by no more than five times the square root of a cross section of the first entrance face. Additionally or alternatively, the first entrance face may be arranged in front of the second entrance face and may be spaced apart from the second entrance face by no more than 50 mm, preferably by no more than 15 mm.

Alternatively to the linear arrangement of the two optical sensors, the optical sensors may be arranged in different beam paths of the detector. The optical receiving fibers may be adapted to generate the first light beam and the second light beam. The first light beam and the second light beam may be generated with different degree of transmission. The first optical sensor may be configured to generate the first sensor signal in response to the illumination of the first light-sensitive area by the first light beam. The second optical sensor may be configured to generate the second sensor signal in response to the illumination of the second light-sensitive area by the second light beam. For example, as outlined above, the optical receiving fibers may comprise at least one multifurcated optical receiving fiber which may be arranged such that the incident light beam may impinge at the first angle of incidence into the first fiber and at the second angle of incidence, different from the first angle, into the second fiber, such that the degree of transmission is different for the first light beam, in this case a first transmission light beam, and the second light beam, in this case a second transmission light beam. One of the first and second optical sensors may be arranged at the exit end of the first fiber and the other optical sensor may be arranged at the exit end of the second fiber.

The evaluation device specifically may be configured for deriving the combined signal Q by dividing the first and second sensor signals, by dividing multiples of the first and second sensor signals or by dividing linear combinations of the first and second sensor signals. As an example, Q may simply be determined as Q=s₁/s₂ or Q=s₂/s₁, with s₁ denoting the first sensor signal and s₂ denoting the second sensor signal. Additionally or alternatively, Q may be determined as Q=a·s₁/b·s₂ or Q=b·s₂/a·s₁, with a and b being real numbers which, as an example, may be predetermined or determinable. Additionally or alternatively, Q may be determined as Q=(a·s₁+b·s₂)/(c·s₁+d·s₂), with a, b, c and d being real numbers which, as an example, may be predetermined or determinable. As a simple example for the latter, Q may be determined as Q=s₁/(s₁+s₂). Other combined or quotient signals are feasible.

Typically, in the setup described above, Q is a monotonous function of the longitudinal coordinate of the object and/or of the size of the light spot such as the diameter or equivalent diameter of the light spot. Thus, as an example, specifically in case linear optical sensors are used, the quotient Q=s₁/s₂ is a monotonously decreasing function of the size of the light spot. Without wishing to be bound by this theory, it is believed that this is due to the fact that, in the setup described above, both the first signal s₁ and the second signal s₂ decrease as a square function with increasing distance to the light source, since the amount of light reaching the detector decreases. Therein, however, the first signal s₁ decreases more rapidly than the second signal s₂, since, in the optical setup as used in the experiments, the light spot in the image plane grows and, thus, is spread over a larger area. The quotient of the first and second sensor signals, thus, continuously decreases with increasing diameter of the light beam or diameter of the light spot on the first and second light-sensitive areas. The quotient, further, is mainly independent from the total power of the light beam, since the total power of the light beam forms a factor both in the first sensor signal and in the second sensor signal. Consequently, the quotient Q may form a secondary signal which provides a unique and unambiguous relationship between the first and second sensor signals and the size or diameter of the light beam. Since, on the other hand, the size or diameter of the light beam is dependent on a distance between the object, from which the incident light beam propagates towards the detector, and the detector itself, i.e. dependent on the longitudinal coordinate of the object, a unique and unambiguous relationship between the first and second sensor signals and the longitudinal coordinate may exist. For the latter, reference e.g. may be made to WO 2014/097181 A1. The predetermined relationship may be determined by analytical considerations, such as by assuming a linear combination of Gaussian light beams, by empirical measurements, such as measurements measuring the first and second sensor signals or a secondary signal derived thereof as a function of the longitudinal coordinate of the object, or both.

In view of the technical challenges involved in the prior art document WO 2014/097181 A1, specifically in view of the technical effort which is required for generating the FiP effect, it has to be noted that the present invention specifically may be realized by using non-FiP optical sensors. In fact, since optical sensors having the FiP characteristic typically exhibit a strong peak in the respective sensor signals at a focal point, the range of measurement of a detector according to the present invention using FiP sensors as optical sensors may be limited to a range in between the two positions and which the first and second optical sensors are in focus of the light beam. When using linear optical sensors, however, i.e. optical sensors not exhibiting the FiP effect, this problem, with the setup of the present invention, generally may be avoided. Consequently, the first and second optical sensor may each have, at least within a range of measurement, a linear signal characteristic such that the respective first and second sensor signals may be dependent on the total power of illumination of the respective optical sensor and may be independent from a diameter of a light spot of the illumination. It shall be noted, however, that other embodiments are feasible, too.

The first and second optical sensors each specifically may be semiconductor sensors, preferably inorganic semiconductor sensors, more preferably photodiodes and most preferably silicon photodiodes. Thus, as opposed to complex and expensive FiP sensors, the present invention simply may be realized by using commercially available inorganic photodiodes, i.e. one small photodiode and one large area photodiode. Thus, the setup of the present invention may be realized in a cheap and inexpensive fashion.

Specifically, the first and second optical sensors, each independently, may be or may comprise inorganic photodiodes which are sensitive in the infrared spectral range, preferably in the range of 780 nm to 3.0 micrometers, and/or sensitive in the visible spectral range, preferably in the range of 380 nm to 780 nm. Specifically, the first and second optical sensors may be sensitive in the part of the near infrared region where silicon photodiodes are applicable specifically in the range of 700 nm to 1000 nm. Infrared optical sensors which may be used for the first optical sensor, for the second optical sensor or for both the first and second optical sensors may be commercially available infrared optical sensors, such as infrared optical sensors commercially available available under the brand name Hertzstueck™ from trinamiX GmbH, D-67056 Ludwigshafen am Rhein, Germany. Thus, as an example, the first optical sensor, the second optical sensor or both the first and the second optical sensor may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the first optical sensor, the second optical sensor or both the first and the second optical sensor may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the first optical sensor, the second optical sensor or both the first and the second optical sensor may comprise at least one bolometer, preferably a bolometer selected from the group consisting of a VO bolometer and an amorphous Si bolometer.

The first and second optical sensors each specifically may be uniform sensors having a single light-sensitive area each. Thus, the first and second optical sensors specifically may be non-pixelated optical sensors.

As outlined above, by evaluating the first and second sensor signals, the detector may be enabled to determine the at least one longitudinal coordinate of the object, including the option of determining the longitudinal coordinate of the whole object or of one or more parts thereof. In addition, however, other coordinates of the object, including one or more transversal coordinates and/or rotational coordinates, may be determined by the detector, specifically by the evaluation device. Thus, as an example, one or more additional transversal sensors may be used for determining at least one transversal coordinate of the object. Various transversal sensors are generally known in the art, such as the transversal sensors disclosed in WO 2014/097181 A1 and/or other position-sensitive devices (PSDs), such as quadrant diodes, CCD or CMOS chips or the like. These devices may generally also be implemented into the detector according to the present invention. As an example, a part of the light beam may be split off within the detector, by at least one beam splitting element. The split-off portion, as an example, may be guided towards a transversal sensor, such as a CCD or CMOS chip or a camera sensor, and a transversal position of a light spot generated by the split-off portion on the transversal sensor may be determined, thereby determining at least one transversal coordinate of the object. Consequently, the detector according to the present invention may either be a one-dimensional detector, such as a simple distance measurement device, or may be embodied as a two-dimensional detector or even as a three-dimensional detector. Further, as outlined above or as outlined in further detail below, by scanning a scenery or an environment in a one-dimensional fashion, a three-dimensional image may also be created. Consequently, the detector according to the present invention specifically may be one of a one-dimensional detector, a two-dimensional detector or a three-dimensional detector. The evaluation device may further be configured to determine at least one transversal coordinate x, y of the object.

The optical sensors may be partial diodes of a bi-cell or quadrant diode and/or comprise at least one CMOS sensor. For example, the optical sensors may comprise a CMOS sensor. The evaluation device may be adapted to divide the sensor region of the CMOS sensor into at least two sub-regions. Specifically, the evaluation device may be adapted to divide the sensor region of the CMOS sensor into at least one left part and at least one right part and/or at least one upper part and at least one lower part and/or at least one inner and at least one outer part. The evaluation device may be configured for determining the at least one longitudinal coordinate z of the object by evaluating the combined signal Q from the sensor signals of the at least two sub-regions. Using at least one CMOS sensor may allow movement of the illumination source for illuminating the object. In particular independent movement of at least one optical illumination fiber and the optical receiving fiber may be possible. In case of using optical sensors arranged as partial diodes of a bi-cell or quadrant diode, the optical receiving fiber and the optical illumination fiber may be interconnected, in particular fixedly. Additionally or alternatively to an illumination using the optical illumination fiber, the object may be illuminated by a light beam generated from an arbitrary illumination source. In particular, the illumination of the object may be performed independently from the optical receiving fiber.

For example, the detector may comprise at least one sensor element having a matrix of optical sensors, the optical sensors each having a light-sensitive area, wherein each optical sensor may be configured to generate at least one sensor signal in response to an illumination of the light-sensitive area by the light beam having passed through one or more optical receiving fibers. The detector may comprise two sensor elements, in particular at least one first sensor element and at least one second sensor element, arranged in different beam paths of the detector. One of the first and second sensors elements may be arranged at the exit end of the first fiber and the other sensor element may be arranged at the exit end of the second fiber.

The evaluation device may be configured for evaluating the sensor signals, by
a) determining at least one optical sensor having the highest sensor signal and forming at least one center signal;
b) evaluating the sensor signals of the optical sensors of the matrix and forming at least one sum signal;
c) determining at least one combined signal by combining the center signal and the sum signal; and
d) determining at least one longitudinal coordinate z of the object by evaluating the combined signal.

As used herein, the term “sensor element” generally refers to a device or a combination of a plurality of devices configured for sensing at least one parameter. In the present case, the parameter specifically may be an optical parameter, and the sensor element specifically may be an optical sensor element. The sensor element may be formed as a unitary, single device or as a combination of several devices. As further used herein, the term “matrix” generally refers to an arrangement of a plurality of elements in a predetermined geometrical order. The matrix, as will be outlined in further detail below, specifically may be or may comprise a rectangular matrix having one or more rows and one or more columns. The rows and columns specifically may be arranged in a rectangular fashion. It shall be outlined, however, that other arrangements are feasible, such as nonrectangular arrangements. As an example, circular arrangements are also feasible, wherein the elements are arranged in concentric circles or ellipses about a center point. For example, the matrix may be a single row of pixels. Other arrangements are feasible.

The optical sensors of the matrix specifically may be equal in one or more of size, sensitivity and other optical, electrical and mechanical properties. The light-sensitive areas of all optical sensors of the matrix specifically may be located in a common plane, the common plane preferably facing the object, such that the light beam having passed through the optical receiving fibers may generate a light spot on the common plane.

As explained in more detail in one or more of the above-mentioned prior art documents, e.g. in WO 2012/110924 A1 or WO 2014/097181 A1, typically, a predetermined or determinable relationship exists between a size of a light spot, such as a diameter of the light spot, a beam waist or an equivalent diameter, and the longitudinal coordinate of the object from which the light beam propagates towards the detector. Without wishing to be bound by this theory, the light spot may be characterized by two measurement variables: a measurement signal measured in a small measurement patch in the center or close to the center of the light spot, also referred to as the center signal, and an integral or sum signal integrated over the light spot, with or without the center signal. For a light beam having a certain total power which does not change when the beam is widened or focused, the sum signal should be independent from the spot size of the light spot, and, thus, should, at least when linear optical sensors within their respective measurement range are used, be independent from the distance between the object and the detector. The center signal, however, is dependent on the spot size. Thus, the center signal typically increases when the light beam is focused and decreases when the light beam is defocused. By comparing the center signal and the sum signal, thus, an item of information on the size of the light spot generated by the light beam and, thus, on the longitudinal coordinate of the object may be generated. The comparing of the center signal and the sum signal, as an example, may be done by forming the combined signal Q out of the center signal and the sum signal and by using a predetermined or determinable relationship between the longitudinal coordinate and the combined signal for deriving the longitudinal coordinate.

The use of a matrix of optical sensors provides a plurality of advantages and benefits. Thus, the center of the light spot generated by the light beam on the sensor element, such as on the common plane of the light-sensitive areas of the optical sensors of the matrix of the sensor element, may vary with a transversal position of the object. By using a matrix of optical sensors, the detector according to the present invention may adapt to these changes in conditions and, thus, may determine the center of the light spot simply by comparing the sensor signals. Consequently, the detector according to the present invention may, by itself, choose the center signal and determine the sum signal and, from these two signals, derive a combined signal which contains information on the longitudinal coordinate of the object. By evaluating the combined signal, the longitudinal coordinate of the object may, thus, be determined. The use of the matrix of optical sensors, thus, provides a significant flexibility in terms of the position of the object, specifically in terms of a transversal position of the object.

The transversal position of the light spot on the matrix of optical sensors, such as the transversal position of the at least one optical sensor generating the sensor signal, may even be used as an additional item of information, from which at least one item of information on a transversal position of the object may be derived, as e.g. disclosed in WO 2014/198629 A1. Additionally or alternatively, as will be outlined in further detail below, the detector according to the present invention may contain at least one additional transversal detector for, in addition to the at least one longitudinal coordinate, detecting at least one transversal coordinate of the object.

Consequently, in accordance with the present invention, the term “center signal” generally refers to the at least one sensor signal comprising essentially center information of the beam profile. As used herein, the term “highest sensor signal” refers to one or both of a local maximum or a maximum in a region of interest. For example, the center signal may be the signal of the at least one optical sensor having the highest sensor signal out of the plurality of sensor signals generated by the optical sensors of the entire matrix or of a region of interest within the matrix, wherein the region of interest may be predetermined or determinable within an image generated by the optical sensors of the matrix. The center signal may arise from a single optical sensor or, as will be outlined in further detail below, from a group of optical sensors, wherein, in the latter case, as an example, the sensor signals of the group of optical sensors may be added up, integrated or averaged, in order to determine the center signal. The group of optical sensors from which the center signal arises may be a group of neighboring optical sensors, such as optical sensors having less than a predetermined distance from the actual optical sensor having the highest sensor signal or may be a group of optical sensors generating sensor signals being within a predetermined range from the highest sensor signal. The group of optical sensors from which the center signal arises may be chosen as large as possible in order to allow maximum dynamic range. The evaluation device may be adapted to determine the center signal by integration of the plurality of sensor signals, for example the plurality of optical sensors around the optical sensor having the highest sensor signal. For example, the beam profile may be a trapezoid beam profile and the evaluation device may be adapted to determine an integral of the trapezoid, in particular of a plateau of the trapezoid.

Similarly, the term “sum signal” generally refers to a signal comprising essentially edge information of the beam profile. For example, the sum signal may be derived by adding up the sensor signals, integrating over the sensor signals or averaging over the sensor signals of the entire matrix or of a region of interest within the matrix, wherein the region of interest may be predetermined or determinable within an image generated by the optical sensors of the matrix. When adding up, integrating over or averaging over the sensor signals, the actual optical sensors from which the sensor signal is generated may be left out of the adding, integration or averaging or, alternatively, may be included into the adding, integration or averaging. The evaluation device may be adapted to determine the sum signal by integrating signals of the entire matrix, or of the region of interest within the matrix. For example, the beam profile may be a trapezoid beam profile and the evaluation device may be adapted to determine an integral of the entire trapezoid. Further, when trapezoid beam profiles may be assumed, the determination of edge and center signals may be replaced by equivalent evaluations making use of properties of the trapezoid beam profile such as determination of the slope and position of the edges and of the height of the central plateau and deriving edge and center signals by geometric considerations.

Additionally or alternatively, the evaluation device may be adapted to determine one or both of center information or edge information from at least one slice or cut of the light spot. This may be realized for example by replacing the area integrals in the combined signal Q by a line integral along the slice or cut. For improved accuracy, several slices or cuts through the light spot may be used and averaged. In case of an elliptical spot profile, averaging over several slices or cuts may result in an improved distance information.

Similarly, the term “combined signal”, as further used herein, generally refers to a signal which is generated by combining the center signal and the sum signal. Specifically, the combination may include one or more of: forming a quotient of the center signal and the sum signal or vice versa; forming a quotient of a multiple of the center signal and a multiple of the sum signal or vice versa; forming a quotient of a linear combination of the center signal and a linear combination of the sum signal or vice versa. Additionally or alternatively, the combined signal may comprise an arbitrary signal or signal combination which contains at least one item of information on a comparison between the center signal and the sum signal.

The light beam may fully illuminate the at least one optical sensor from which the center signal is generated, such that the at least one optical sensor from which the center signal arises is fully located within the light beam, with a width of the light beam being larger than the light-sensitive area of the at least one optical sensor from which the sensor signal arises. Contrarily, preferably, the light beam may create a light spot on the entire matrix which is smaller than the matrix, such that the light spot is fully located within the matrix. This situation may easily be adjusted by a person skilled in the art of optics by choosing one or more appropriate lenses or elements having a focusing or defocusing effect on the light beam, such as by using an appropriate transfer device as will be outlined in further detail below. As further used herein, a “light spot” generally refers to a visible or detectable round or non-round illumination of an article, an area or object by a light beam.

As outlined above, the center signal generally may be a single sensor signal, such as a sensor signal from the optical sensor in the center of the light spot, or may be a combination of a plurality of sensor signals, such as a combination of sensor signals arising from optical sensors in the center of the light spot, or a secondary sensor signal derived by processing a sensor signal derived by one or more of the aforementioned possibilities. The determination of the center signal may be performed electronically, since a comparison of sensor signals is fairly simply implemented by conventional electronics or may be performed fully or partially by software. Specifically, the center signal may be selected from the group consisting of: the highest sensor signal; an average of a group of sensor signals being within a predetermined range of tolerance from the highest sensor signal; an average of sensor signals from a group of optical sensors containing the optical sensor having the highest sensor signal and a predetermined group of neighboring optical sensors; a sum of sensor signals from a group of optical sensors containing the optical sensor having the highest sensor signal and a predetermined group of neighboring optical sensors; a sum of a group of sensor signals being within a predetermined range of tolerance from the highest sensor signal; an average of a group of sensor signals being above a predetermined threshold; a sum of a group of sensor signals being above a predetermined threshold; an integral of sensor signals from a group of optical sensors containing the optical sensor having the highest sensor signal and a predetermined group of neighboring optical sensors; an integral of a group of sensor signals being within a predetermined range of tolerance from the highest sensor signal; an integral of a group of sensor signals being above a predetermined threshold.

As outlined above, raw sensor signals of the optical sensors may be used for evaluation or secondary sensor signals derived thereof. As used herein, the term “secondary sensor signal” generally refers to a signal, such as an electronic signal, more preferably an analogue and/or a digital signal, which is obtained by processing one or more raw signals, such as by filtering, averaging, demodulating or the like. Thus, image processing algorithms may be used for generating secondary sensor signals from the totality of sensor signals of the matrix or from a region of interest within the matrix. Specifically, the detector, such as the evaluation device, may be configured for transforming the sensor signals of the optical sensor, thereby generating secondary optical sensor signals, wherein the evaluation device is configured for performing steps a)-d) by using the secondary optical sensor signals. The transformation of the sensor signals specifically may comprise at least one transformation selected from the group consisting of: a filtering; a selection of at least one region of interest; a formation of a difference image between an image created by the sensor signals and at least one offset; an inversion of sensor signals by inverting an image created by the sensor signals; a formation of a difference image between an image created by the sensor signals at different times; a background correction; a decomposition into color channels; a decomposition into hue; saturation; and brightness channels; a frequency decomposition; a singular value decomposition; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wavelet-transformation; a thresholding; creating a binary image. The region of interest may be determined manually by a user or may be determined automatically, such as by recognizing an object within an image generated by the optical sensors. As an example, a vehicle, a person or another type of predetermined object may be determined by automatic image recognition within an image, i.e. within the totality of sensor signals generated by the optical sensors, and the region of interest may be chosen such that the object is located within the region of interest. In this case, the evaluation, such as the determination of the longitudinal coordinate, may be performed for the region of interest, only. Other implementations, however, are feasible.

As outlined above, the detection of the center of the light spot, i.e. the detection of the center signal and/or of the at least one optical sensor from which the center signal arises, may be performed fully or partially electronically or fully or partially by using one or more software algorithms. Specifically, the evaluation device may comprise at least one center detector for detecting the at least one highest sensor signal and/or for forming the center signal. The center detector specifically may fully or partially be embodied in software and/or may fully or partially be embodied in hardware. The center detector may fully or partially be integrated into the at least one sensor element and/or may fully or partially be embodied independently from the sensor element.

As outlined above, the sum signal may be derived from all sensor signals of the matrix, from the sensor signals within a region of interest or from one of these possibilities with the sensor signals arising from the optical sensors contributing to the center signal excluded. In every case, a reliable sum signal may be generated which may be compared with the center signal reliably, in order to determine the longitudinal coordinate. Generally, the sum signal may be selected from the group consisting of: an average over all sensor signals of the matrix; a sum of all sensor signals of the matrix; an integral of all sensor signals of the matrix; an average over all sensor signals of the matrix except for sensor signals from those optical sensors contributing to the center signal; a sum of all sensor signals of the matrix except for sensor signals from those optical sensors contributing to the center signal; an integral of all sensor signals of the matrix except for sensor signals from those optical sensors contributing to the center signal; a sum of sensor signals of optical sensors within a predetermined range from the optical sensor having the highest sensor signal; an integral of sensor signals of optical sensors within a predetermined range from the optical sensor having the highest sensor signal; a sum of sensor signals above a certain threshold of optical sensors being located within a predetermined range from the optical sensor having the highest sensor signal; an integral of sensor signals above a certain threshold of optical sensors being located within a predetermined range from the optical sensor having the highest sensor signal. Other options, however, exist.

The summing may be performed fully or partially in software and/or may be performed fully or partially in hardware. A summing is generally possible by purely electronic means which, typically, may easily be implemented into the detector. Thus, in the art of electronics, summing devices are generally known for summing two or more electrical signals, both analogue signals and digital signals. Thus, the evaluation device may comprise at least one summing device for forming the sum signal. The summing device may fully or partially be integrated into the sensor element or may fully or partially be embodied independently from the sensor element. The summing device may fully or partially be embodied in one or both of hardware or software.

As outlined above, the comparison between the center signal and the sum signal specifically may be performed by forming one or more quotient signals. Thus, generally, the combined signal may be a quotient signal, derived by one or more of: forming a quotient of the center signal and the sum signal or vice versa; forming a quotient of a multiple of the center signal and a multiple of the sum signal or vice versa; forming a quotient of a linear combination of the center signal and a linear combination of the sum signal or vice versa; forming a quotient of the center signal and a linear combination of the sum signal and the center signal or vice versa; forming a quotient of the sum signal and a linear combination of the sum signal and the center signal or vice versa; forming a quotient of an exponentiation of the center signal and an exponentiation of the sum signal or vice versa. Other options, however, exist. The evaluation device may be configured for forming the one or more quotient signals. The evaluation device may further be configured for determining the at least one longitudinal coordinate by evaluating the at least one quotient signal.

The evaluation device specifically may be configured for using at least one predetermined relationship between the combined signal Q and the longitudinal coordinate, in order to determine the at least one longitudinal coordinate. Thus, due to the reasons disclosed above and due to the dependency of the properties of the light spot on the longitudinal coordinate, the combined signal Q typically is a monotonous function of the longitudinal coordinate of the object and/or of the size of the light spot such as the diameter or equivalent diameter of the light spot. Thus, as an example, specifically in case linear optical sensors are used, a simple quotient of the sensor signal s_{center} and the sum signal sₛᵤₘ Q=s_{center}/sₛᵤₘ may be a monotonously decreasing function of the distance. Without wishing to be bound by this theory, it is believed that this is due to the fact that, in the preferred setup described above, both the center signal s_{center} and the sum signal sₛᵤₘ decrease as a square function with increasing distance to the light source, since the amount of light reaching the detector decreases. Therein, however, the center signal s_{center} decreases more rapidly than the sum signal sₛᵤₘ, since, in the optical setup as used in the experiments, the light spot in the image plane grows and, thus, is spread over a larger area. The quotient of the center signal and the sum signal, thus, continuously decreases with increasing diameter of the light beam or diameter of the light spot on the light-sensitive areas of the optical sensors of the matrix. The quotient, further, is typically independent from the total power of the light beam, since the total power of the light beam forms a factor both in the center signal and in the sum sensor signal. Consequently, the quotient Q may form a secondary signal which provides a unique and unambiguous relationship between the center signal and the sum signal and the size or diameter of the light beam. Since, on the other hand, the size or diameter of the light beam is dependent on a distance between the object, from which the light beam propagates towards the detector, and the detector itself, i.e. dependent on the longitudinal coordinate of the object, a unique and unambiguous relationship between the center signal and the sum signal on the one hand and the longitudinal coordinate on the other hand may exist. For the latter, reference e.g. may be made to one or more of the above-mentioned prior art documents, such as WO 2014/097181 A1. The predetermined relationship may be determined by analytical considerations, such as by assuming a linear combination of Gaussian light beams, by empirical measurements, such as measurements measuring the combined signal and/or the center signal and the sum signal or secondary signals derived thereof as a function of the longitudinal coordinate of the object, or both.

Thus, generally, the evaluation device may be configured for determining the longitudinal coordinate by evaluating the combined signal Q such as the quotient signal. This determining may be a one-step process, such as by directly combining the center signal and the sum signal and deriving the longitudinal coordinate thereof, or may be a multiple step process, such as by firstly deriving the combined signal from the center signal and the sum signal and, secondly, by deriving the longitudinal coordinate from the combined signal. Both options, i.e. the option of steps c) and d) being separate and independent steps and the option of steps c) and d) being fully or partially combined, shall be comprised by the present invention.

The evaluation device may be configured for using at least one predetermined relationship between the combined signal and the longitudinal coordinate. The predetermined relationship may be one or more of an empiric relationship, a semi-empiric relationship and an analytically derived relationship. The evaluation device may comprise at least one data storage device for storing the predetermined relationship, such as a lookup list or a lookup table.

As outlined above, the optical sensors specifically may be or may comprise photodetectors, preferably inorganic photodetectors, more preferably inorganic semiconductor photodetectors, most preferably silicon photodetectors. Specifically, the optical sensors may be sensitive in the infrared spectral range. All of the optical sensors of the matrix or at least a group of the optical sensors of the matrix specifically may be identical. Groups of identical optical sensors of the matrix specifically may be provided for different spectral ranges, or all optical sensors may be identical in terms of spectral sensitivity. Further, the optical sensors may be identical in size and/or with regard to their electronic or optoelectronic properties.

The matrix may be composed of independent optical sensors. Thus, a matrix of inorganic photodiodes may be composed. Alternatively, however, a commercially available matrix may be used, such as one or more of a CCD detector, such as a CCD detector chip, and/or a CMOS detector, such as a CMOS detector chip.

Thus, generally, the optical sensors of the detector may form a sensor array or may be part of a sensor array, such as the above-mentioned matrix. Thus, as an example, the detector may comprise an array of optical sensors, such as a rectangular array, having m rows and n columns, with m, n, independently, being positive integers. Preferably, more than one column and more than one row is given, i.e. n>1, m>1. Thus, as an example, n may be 2 to 16 or higher and m may be 2 to 16 or higher. Preferably, the ratio of the number of rows and the number of columns is close to 1. As an example, n and m may be selected such that 0.3≤m/n≤3, such as by choosing m/n=1:1, 4:3, 16:9 or similar. As an example, the array may be a square array, having an equal number of rows and columns, such as by choosing m=2, n=2 or m=3, n=3 or the like.

As further outlined above, the matrix specifically may be a rectangular matrix having at least one row, preferably a plurality of rows, and a plurality of columns. As an example, the rows and columns may be oriented essentially perpendicular, wherein, with respect to the term “essentially perpendicular”, reference may be made to the definition given above. Thus, as an example, tolerances of less than 20°, specifically less than 100 or even less than 5°, may be acceptable. In order to provide a wide range of view, the matrix specifically may have at least 10 rows, preferably at least 50 rows, more preferably at least 100 rows. Similarly, the matrix may have at least 10 columns, preferably at least 50 columns, more preferably at least 100 columns. The matrix may comprise at least 50 optical sensors, preferably at least 100 optical sensors, more preferably at least 500 optical sensors. The matrix may comprise a number of pixels in a multi-mega pixel range. Other embodiments, however, are feasible. Thus, as outlined above, in setups in which an axial rotational symmetry is to be expected, circular arrangements or concentric arrangements of the optical sensors of the matrix, which may also be referred to as pixels, may be preferred.

The illumination source may be adapted to generate and/or to project a cloud of points such that a plurality of illuminated regions is generated on the matrix of optical sensors, for example the CMOS detector. Additionally, disturbances may be present on the matrix of optical sensors such as disturbances due to speckles and/or extraneous light and/or multiple reflections. The evaluation device may be adapted to determine at least one region of interest, for example one or more pixels illuminated by the light beam which are used for determination of the longitudinal coordinate of the object. For example, the evaluation device may be adapted to perform a filtering method, for example, a blob-analysis and/or object recognition method.

As outlined above, by evaluating the center signal and the sum signal, the detector may be enabled to determine the at least one longitudinal coordinate of the object, including the option of determining the longitudinal coordinate of the whole object or of one or more parts thereof. In addition, however, other coordinates of the object, including one or more transversal coordinates and/or rotational coordinates, may be determined by the detector, specifically by the evaluation device. Thus, as an example, one or more transversal sensors may be used for determining at least one transversal coordinate of the object. As outlined above, the position of the at least one optical sensor from which the center signal arises may provide information on the at least one transversal coordinate of the object, wherein, as an example, a simple lens equation may be used for optical transformation and for deriving the transversal coordinate. Additionally or alternatively, one or more additional transversal sensors may be used and may be comprised by the detector. Various transversal sensors are generally known in the art, such as the transversal sensors disclosed in WO 2014/097181 A1 and/or other position-sensitive devices (PSDs), such as quadrant diodes, CCD or CMOS chips or the like. Additionally or alternatively, as an example, the detector according to the present invention may comprise one or more PSDs disclosed in R. A. Street: Technology and Applications of Amorphous Silicon, Springer-Verlag Heidelberg, 2010, pp. 346-349. Other embodiments are feasible. These devices may generally also be implemented into the detector according to the present invention. As an example, a part of the light beam may be split off within the detector, by at least one beam splitting element. The split-off portion, as an example, may be guided towards a transversal sensor, such as a CCD or CMOS chip or a camera sensor, and a transversal position of a light spot generated by the split-off portion on the transversal sensor may be determined, thereby determining at least one transversal coordinate of the object. Consequently, the detector according to the present invention may either be a one-dimensional detector, such as a simple distance measurement device, or may be embodied as a two-dimensional detector or even as a three-dimensional detector. Further, as outlined above or as outlined in further detail below, by scanning a scenery or an environment in a one-dimensional fashion, a three-dimensional image may also be created. Consequently, the detector according to the present invention specifically may be one of a one-dimensional detector, a two-dimensional detector or a three-dimensional detector. The evaluation device may further be configured to determine at least one transversal coordinate x, y of the object. The evaluation device may be adapted to combine the information of the longitudinal coordinate and the transversal coordinate and to determine a position of the object in space.

In an embodiment the detector may comprise at least two optical sensors, each optical sensor having a light-sensitive area, wherein each light-sensitive area has a geometrical center, wherein the geometrical centers of the optical sensors are spaced apart from an optical axis of the detector by different spatial offsets, wherein each optical sensor is configured to generate a sensor signal in response to an illumination of its respective light-sensitive area by the light beam having passed through the optical receiving fibers. The evaluation device may be configured for determining at least one longitudinal coordinate z of the object by combining the at least two sensor signals.

The light-sensitive areas of the optical sensors may overlap, as visible from the object, or may not overlap, i.e. may be placed next to each other without overlap. The light-sensitive areas may be spaced apart from each other or may directly be adjacent. The optical sensors may be located in one and the same beam path or partial beam path. Alternatively, however, the optical sensors may also be located in different partial beam paths. In case the optical sensors are distributed over different partial beam paths, the above-mentioned condition may be described such that at least one first optical sensor is located in at least one first partial beam path, being offset from the optical axis of the first partial beam path by a first spatial offset, and at least one second optical sensor is located in at least one second partial beam path, being offset from the optical axis of the second partial beam path by at least one second spatial offset, wherein the first spatial offset and the second spatial offset are different.

The detector may comprise more than two optical sensors. In any case, i.e. in the case of the detector comprising precisely two optical sensors and in the case of the detector comprising more than two optical sensors, the optical sensors may comprise at least one first optical sensor being spaced apart from the optical axis by a first spatial offset and at least one second optical sensor being spaced apart from the optical axis by a second spatial offset, wherein the first spatial offset and the second spatial offset differ. In case further optical sensors are provided, besides the first and second optical sensors, these additional optical sensors may also fulfill the condition or, alternatively, may be spaced apart from the optical axis by the first spatial offset, by the second spatial offset or by a different spatial offset. The first and second spatial offsets, as an example, may differ by at least a factor of 1.2, more preferably by at least a factor of 1.5, more preferably by at least a factor of 2. As outlined above, each light-sensitive area has a geometrical center. Each geometrical center of each light-sensitive area may be spaced apart from the optical axis of the detector, such as the optical axis of the beam path or the respective beam path in which the respective optical sensor is located. As outlined above, the optical sensors and/or the entrance faces of the receiving fibers specifically may be located in one and the same plane, which, preferably, is a plane perpendicular to the optical axis. Other configurations, however, are possible. Thus, two or more of the optical sensors and/or entrance faces of the receiving fibers may also be spaced apart in a direction parallel to the optical axis.

For example, the optical sensors may be partial diodes of a segmented diode, with a center of the segmented diode being off-centered from the optical axis of the detector. The optical sensors may be partial diodes of a bi-cell or quadrant diode and/or comprise at least one CMOS sensor. As used herein, the term “partial diode” may comprise several diodes that are connected in series or in parallel. This example is rather simple and cost-efficiently realizable. Thus, as an example, bi-cell diodes or quadrant diodes are widely commercially available at low cost, and driving schemes for these bi-cell diodes or quadrant diodes are generally known. As used herein, the term “bi-cell diode” generally refers to a diode having two partial diodes in one packaging. Bi-cell and quadrant diodes may have two or four separate light sensitive areas, in particular two or four active areas. As an example, the bi-cell diodes may each form independent diodes having the full functionality of a diode. As an example, each of the bi-cell diodes may have a square or rectangular shape, and the two diodes may be placed in one plane such that the two partial diodes, in total, form a 1×2 or 2×1 matrix having a rectangular shape. In the present invention, however, a new scheme for evaluating the sensor signals of the bi-cell diodes and quadrant diode is proposed, as will be outlined in further detail below. Generally, however, the optical sensors specifically may be partial diodes of a quadrant diode, with a center of the quadrant diode being off-centered from the optical axis of the detector. As used herein, the term “quadrant diode” generally refers to a diode having four partial diodes in one packaging. As an example, the four partial diodes may each form independent diodes having the full functionality of a diode. As an example, the four partial diodes may each have a square or rectangular shape, and the four partial diodes may be placed in one plane such that the four partial diodes, in total, form a 2×2 matrix having a rectangular or square shape. In a further example, the four partial diodes, in total, may form a 2×2 matrix having a circular or elliptical shape. The partial diodes, as an example, may be adjacent, with a minimum separation from one another.

In case a quadrant diode is used, having a 2×2 matrix of partial diodes, the center of the quadrant diode specifically may be off-centered or offset from the optical axis. Thus, as an example, the center of the quadrant diodes, which may be an intersection of the geometrical centers of the optical sensors of the quadrant diode, may be off-centered from the optical axis by at least 0.2 mm, more preferably by at least 0.5 mm, more preferably by at least 1.0 mm or even 2.0 mm. Similarly, when using other types of optical sensors setups having a plurality of optical sensors, an overall center of the optical sensors may be offset from the optical axis by the same distance.

Generally, the light-sensitive areas of the optical sensors may have an arbitrary surface area or size. Preferably, however, specifically in view of a simplified evaluation of the sensor signals, the light-sensitive areas of the optical sensors are substantially equal, such as within a tolerance of less than 10%, preferably less than 5% or even less than 1%. This, specifically, is the case in typical commercially available quadrant diodes.

In typical setups, commercially available quadrant diodes such as quadrant photodiodes are used for positioning, i.e. for adjusting and/or measuring a transversal coordinate of a light spot in the plane of the quadrant photodiode. Thus, as an example, laser beam positioning by using quadrant photodiodes is well known. According to a typical prejudice, however, quadrant photodiodes are used for xy-positioning, only. According to this assumption, quadrant photodiodes are not suitable for measuring distances. The above-mentioned findings, however, using an off-centered quadrant photodiode with regard to an optical axis of the detector, show otherwise, as will be shown in further measurements below. Thus, as indicated above, in quadrant photodiodes, the asymmetry of the spot can be measured by shifting the quadrant diode slightly off-axis, such as by the above-mentioned offset. Thereby, a monotonously z-dependent function may be generated, such as by forming the combined signal Q of two or more of the sensor signals of two or more partial photodiodes, i.e. quadrants, of the quadrant photodiode. Therein, in principle, only two photodiodes are necessary for the measurement. The other two diodes may be used for noise cancellation or to obtain a more precise measurement.

In addition or as an alternative to using a quadrant diode or quadrant photodiode, other types of optical sensors may be used. Thus, for example, staggered optical sensors may be used.

The use of quadrant diodes provides a large number of advantages over known optical detectors. Thus, quadrant diodes are used in a large number of applications in combination with LEDs or active targets and are widely commercially available at very low price, with various optical properties such as spectral sensitivities and in various sizes. No specific manufacturing process has to be established, since commercially available products may be implemented into the detector according to the present invention.

As will be outlined in further detail below, the distance measurement by using the detector according to the present invention may be enhanced by implementing one or more additional distance measurement means into the detector and/or by combining the detector with other types of distance measurement means. Thus, as an example, the detector may comprise or may be combined with at least one triangulation distance measurement device. Thus, the distance measurement can be enhanced by making use of a combination of the measurement principle discussed above and a triangulation type distance measurement. Further, means for measuring one or more other coordinates, such as x- and/or y-coordinates, may be provided. In case a quadrant diode is used, the quadrant diode may also be used for additional purposes. Thus, the quadrant diode may also be used for conventional x-y-measurements of a light spot, as generally known in the art of optoelectronics and laser physics. Thus, as an example, the lens or detector position can be adjusted using the conventional xy-position information of the quadrant diode to optimize the position of the spot for the distance measurement. As a practical example, the light spot, initially, may be located right in the center of the quadrant diode, which typically does not allow for the above-mentioned distance measurement using the quotient function Q. Thus, firstly, conventional quadrant photodiode techniques may be used for off-centering a position of the light spot on the quadrant photodiode, such that, e.g., the spot position on the quadrant diode is optimal for the measurement. Thus, as an example, the different off-centering of the optical sensors of the detector may simply be a starting point for movement of the optical sensors relative to the optical axis such that the light spot is off-centered with respect to the optical axis and with respect to a geometrical center of the array of the optical sensors.

Thus, generally, the optical sensors of the detector may form a sensor array or may be part of a sensor array, such as the above-mentioned quadrant diode. Thus, as an example, the detector may comprise an array of optical sensors, such as a rectangular array, having m rows and n columns, with m, n, independently, being positive integers. Preferably, more than one column and more than one row is given, i.e. n>1, m>1. Thus, as an example, n may be 2 to 16 or higher and m may be 2 to 16 or higher. Preferably, the ratio of the number of rows and the number of columns is close to 1. As an example, n and m may be selected such that 0.3≤m/n≤3, such as by choosing m/n=1:1, 4:3, 16:9 or similar. As an example, the array may be a square array, having an equal number of rows and columns, such as by choosing m=2, n=2 or m=3, n=3 or the like. The case m=2, n=2 is the case of the quadrant diode or quadrant optical sensor, which, for practical reasons, is one of the preferred cases, since quadrant photodiodes are widely available.

As a starting point, a geometrical center of the entrance faces of the optical receiving fibers within the array may be off-centered from the optical axis, such as by a certain offset. The entrance faces of the optical receiving fibers specifically may be movable relative to the optical axis, for example along a gradient, preferably automatically, such as by moving the entrance faces of the optical receiving fibers, e.g. in a plane perpendicular to the optical axis, and/or by moving the optical axis itself, e.g. shifting the optical axis in a parallel shift and/or tilting the optical axis. Thus, the entrance faces of the optical receiving fibers may be shifted in order to adjust a position of a light spot generated by the light beam in the plane of the entrance faces of the optical receiving fibers. Additionally or alternatively, the optical axis may be shifted and/or tilted by using appropriate elements, such as by using one or more deflection elements and/or one or more lenses. The movement, as an example, may take place by using one or more appropriate actuators, such as one or more piezo actuators and/or one or more electromagnetic actuators and/or one or more pneumatic or mechanical actuators, which, e.g., move and/or shift the entrance faces of the optical receiving fibers and/or move and/or shift and/or tillage one or more optical elements in the beam path in order to move the optical axis, such as parallel shifting the optical axis and/or tilting the optical axis. The evaluation device specifically may be adjusted to control a relative position of the sensor array to the optical axis, e.g. in the plane perpendicular to the optical axis. An adjustment procedure may take place in that the evaluation device is configured for, firstly, determining the at least one transversal position of a light spot generated by the light beam on the entrance faces of the optical receiving fibers by using the sensor signals and for, secondly, moving the array relative to the optical axis, such as by moving the entrance faces of the optical receiving fibers and/or the optical axis, e.g. by moving the entrance faces of the optical receiving fibers in the plane to the optical axis until the light spot is off-centered and/or by tilting a lens until the light spot is off-centered. As used therein, a transversal position may be a position in a plane perpendicular to the optical axis, which may also be referred to as the x-y-plane. For the measurement of the transversal coordinate, as an example, the sensor signals of the optical sensors may be compared. As an example, in case the sensor signals are found to be equal and, thus, in case it is determined that the light spot is located symmetrically with respect to the optical sensors, such as in the center of the quadrant diodes, a shifting of the entrance faces of the optical receiving fibers and/or a tilting of a lens may take place, in order to off-center the light spot in the entrance faces of the optical receiving fibers. Thus, the off-centering of the entrance faces of the optical receiving fibers from the optical axis, such as by off-centering the center of the entrance faces of the optical receiving fibers from the optical axis, may simply be a starting point in order to avoid the situation which is typical, in which the light spot is located on the optical axis and, thus, is centered. By off-centering the array relative to the optical axis, thus, the light spot should be off-centered. In case this is found not to be true, such that the light spot, incidentally, is located in the center of the entrance faces of the optical receiving fibers and equally illuminates all entrance faces of the optical receiving fibers, the above-mentioned shifting of the array relative to the optical axis may take place, preferably automatically, in order to off-center the light spot on the entrance faces of the optical receiving fibers. Thereby, a reliable distance measurement may take place. Further, in a scanning system with a movable light source, the position of the light spot on the quadrant diode may not be fixed. This is still possible, but may necessitate that different calibrations are used, dependent on the xy-position of the spot in the diode.

As outlined above, specifically, quadrant photodiodes may be used. As an example, commercially available quadrant photodiodes may be integrated in order to provide four optical sensors, such as one or more quadrant photodiodes available from Hamamatsu Photonics Deutschland GmbH, D-82211 Herrsching am Ammersee, Germany, such as quadrant Si PIN photodiodes of the type S4349, which are sensitive in the UV spectral range to the near IR spectral range. In case an array of optical sensors is used, the array may be a naked chip or may be an encapsulated array, such as encapsulated in a TO-5 metal package. Additionally or alternatively, a surface mounted device may be used, such as TT Electronics OPR5911 available from TT Electronics plc, Fourth Floor, St Andrews House, West Street Woking Surrey, GU216EB, England. It shall be noted that other optical sensors may also be used.

Further, it shall be noted that, besides the option of using precisely one quadrant photodiode, two or more quadrant photodiodes may also be used. Thus, as an example, a first quadrant photodiode may be used for the distance measurement, as described above, providing the two or more optical sensors. Another quadrant photodiode may be used, e.g. in a second partial beam path split off from the beam path of the first quadrant photodiode, for a transversal position measurement, such as for using at least one transversal coordinate x and/or y. The second quadrant photodiode, as an example, may be located on-axis with respect to the optical axis.

Further, it shall be noted that, besides the option of using one or more quadrant photodiodes, one or more quadrant photodiodes or further photodiode arrays may also be replaced or mimicked by separated photodiodes that are arranged or assembled close to each other, preferably in a symmetric shape such as a rectangular matrix, such as a 2×2 matrix. However, further arrangements are feasible. In such an arrangement or assembly, the photodiodes may be arranged or assembled in a housing or mount, such as all photodiodes in a single housing or mount or groups of photodiodes in one housing or mount, or each of the photodiodes in a separate housing or mount. Further, the photodiodes may also be assembled directly on a circuit board. In such arrangements or assemblies, photodiodes may be arranged as such that the separation between the active area of the photodiodes, has a distinct value less than one centimeter, preferably less than one millimeter, more preferably as small as possible. Further, to avoid optical reflexes, distortions, or the like that may deteriorate the measurement, the space between the active areas may be either empty or filled with a material, preferably with a light absorbing material such as a black polymer, such as black silicon, black polyoxymethylene, or the like, more preferably optically absorbing and electrically insulating material, such as black ceramics or insulating black polymers such as black silicon, or the like. Further, the distinct value of the photodiode separation may also be realized by adding a distinct building block between the photodiodes such as a plastic separator. Further embodiments are feasible. The replacement of quadrant photodiodes by single diodes arranged in a similar setup such as in a 2×2 rectangular matrix with minimal distance between the active areas may further minimize the costs for the optical detector. Further, two or more diodes from a quadrant diode may be connected in parallel or in series to form a single light-sensitive area.

The optical sensors each, independently, may be opaque, transparent or semitransparent. For the sake of simplicity, however, opaque sensors which are not transparent for the light beam, may be used, since these opaque sensors generally are widely commercially available.

The above-mentioned operations, including determining the at least one longitudinal coordinate of the object, are performed by the at least one evaluation device. Thus, as an example, one or more of the above-mentioned relationships may be implemented in software and/or hardware, such as by implementing one or more lookup tables. Thus, as an example, the evaluation device may comprise one or more programmable devices such as one or more computers, application-specific integrated circuits (ASICs), Field Programmable Gate Arrays (FPGAs), or digital signal processors (DSPs) which are configured to perform the above-mentioned evaluation, in order to determine the at least one longitudinal coordinate of the object. Additionally or alternatively, however, the evaluation device may also fully or partially be embodied by hardware.

The detector may be configured for evaluating a single light beam or a plurality of light beams. In case a plurality of light beams propagates from the object to the detector, means for distinguishing the light beams may be provided. Thus, the light beams may have different spectral properties, and the detector may comprise one or more wavelength selective elements for distinguishing the different light beams. Each of the light beams may then be evaluated independently. The wavelength selective elements, as an example, may be or may comprise one or more filters, one or more prisms, one or more gratings, one or more dichroitic mirrors or arbitrary combinations thereof. Further, additionally or alternatively, for distinguishing two or more light beams, the light beams may be modulated in a specific fashion. Thus, as an example, the light beams may be frequency modulated, and the sensor signals may be demodulated in order to distinguish partially the sensor signals originating from the different light beams, in accordance with their demodulation frequencies. These techniques generally are known to the skilled person in the field of high-frequency electronics. Generally, the evaluation device may be configured for distinguishing different light beams having different modulations.

As outlined above, the detector may further comprise one or more additional elements such as one or more additional optical elements. Further, the detector may fully or partially be integrated into at least one housing.

The kit further may comprise at least one beacon device adapted to direct at least one light beam towards the detector, wherein the beacon device is at least one of attachable to the object, holdable by the object and integratable into the object. The at least one beacon device may be or may comprise at least one active beacon device, comprising one or more illumination sources such as one or more light sources like lasers, LEDs, light bulbs or the like. As an example, the light emitted by the illumination source may have a wavelength of 300 to 1000 nm, especially 500 to 1000 nm. Alternatively, as outlined above, the infrared spectral range may be used, such as in the range of 780 nm to 3.0 μm. Specifically, the near infrared region where silicon photodiodes are applicable specifically in the range of 700 nm to 1000 nm may be used. The light emitted by the one or more beacon devices may be non-modulated or may be modulated, as outlined above, in order to distinguish two or more light beams. Additionally or alternatively, the at least one beacon device may be adapted to reflect one or more light beams towards the detector, such as by comprising one or more reflective elements. Further, the at least one beacon device may be or may comprise one or more scattering elements adapted for scattering a light beam. Therein, elastic or inelastic scattering may be used. In case the at least one beacon device is adapted to reflect and/or scatter a primary light beam towards the detector, the beacon device may be adapted to leave the spectral properties of the light beam unaffected or, alternatively, may be adapted to change the spectral properties of the light beam, such as by modifying a wavelength of the light beam.

In a further aspect, the present invention discloses a method for determining a position of at least one object by using a kit according to the present invention, such as according to one or more of the embodiments referring to a detector as disclosed above or as disclosed in further detail below. Still, other types of kits may be used. The method comprises the following method steps, wherein the method steps may be performed in the given order or may be performed in a different order. Further, one or more additional method steps may be present which are not listed. Further, one, more than one or even all of the method steps may be performed repeatedly.

The method comprises the following steps:
i) providing at least one measurement head, the measurement head comprising:
at least one transfer device, wherein the transfer device has at least one focal length in response to the at least one incident light beam propagating from the object to the measurement head;
at least two optical receiving fibers, wherein at least one of the optical receiving fibers and/or the transfer device has a ratio εᵣ/k≥0.362 (m·K)/W, wherein k is the thermal conductivity and Σr is the relative permittivity;
ii) providing at least one detector, the detector comprising at least two optical sensors, wherein each optical sensor has at least one light-sensitive area, wherein each optical sensor is designed to generate at least one sensor signal in response to an illumination of its respective light-sensitive area by a light beam having passed through at least one of the optical receiving fibers of the measurement head;
iii) illuminating each light-sensitive area of at least two optical sensors of the detector with at least one light beam having passed through at least one of the optical receiving fibers, wherein, thereby, each of the light-sensitive areas generates at least one sensor signal; and
iv) evaluating the sensor signals, thereby, determining at least one longitudinal coordinate z of the object, wherein the evaluating comprises deriving a combined signal Q of the sensor signals.

Specifically, evaluating the first and second sensor signal may comprise deriving the combined signal Q by dividing the first and second sensor signals, by dividing multiples of the first and second sensor signals or by dividing linear combinations of the first and second sensor signals. Further, the determining of the longitudinal coordinate may comprise evaluating the combined signal Q. For details, options and definitions, reference may be made to the detector as discussed above. Thus, specifically, as outlined above, the method may comprise using the detector according to the present invention, such as according to one or more of the embodiments given above or given in further detail below.

In a further aspect of the present invention, use of the kit according to the present invention, such as according to one or more of the embodiments given above or given in further detail below, is proposed, for a purpose of use, selected from the group consisting of: a position measurement in traffic technology; an entertainment application; an optical data storage application; a security application; a surveillance application; a safety application; a human-machine interface application; a tracking application; a photography application; an imaging application or camera application; an industrial sensing application; a medical application; a 3D printing application; a mapping application for generating maps of at least one space; a homing or tracking beacon detector for vehicles; a machine vision application; a robotics application; a quality control application; a manufacturing application.

For further uses of the measurement head and kit according to the present application, reference is made to WO 2018/091640 A1, the full content of which is herewith included by reference.

Overall, in the context of the present invention, the following embodiments are regarded as preferred:

Embodiment 1: A measurement head for determining a position of at least one object comprising:
at least one transfer device, wherein the transfer device has at least one focal length in response to the at least one incident light beam propagating from the object to the measurement head;
at least two optical receiving fibers, wherein at least one of the optical receiving fibers and/or the transfer device has a ratio εᵣ/k≥0.362 (m·K)/W, wherein k is the thermal conductivity and εᵣ is the relative permittivity.

Embodiment 2: The measurement head according to the preceding embodiment, wherein at least one of the optical receiving fibers and/or the transfer device has the ratio εᵣ/k≥0.743 (m·K)/W, preferably the ratio is εᵣ/k≥1.133 (m·K)/W.

Embodiment 3: The measurement head according to any one of the preceding embodiments, wherein the ratio εᵣ/k is in the range 0.362 (m·K)/W≤εᵣ/k≤1854 (m·K)/W, wherein k is the thermal conductivity and εᵣ is the relative permittivity.

Embodiment 4: The measurement head according to the preceding embodiment, wherein the ratio εᵣ/k is in the range 0.743 (m·K)/W≤εᵣ/k≤194 (m·K)/W, preferably the ratio εᵣ/k is in the range 1.133 (m·K)/W≤εᵣ/k≤88.7 (m·K)/W.

Embodiment 5: The measurement head according to any one of the preceding embodiments, wherein the transfer device has a ratio vₑ/n_{D} in the range 9.05≤vₑ/n_{D}≤77.3, wherein vₑ is the Abbé-number and n_{D} is the refractive index, wherein the Abbé-number vₑ is given by

$${v}_{e} = \frac{( {n}_{D} - 1 )}{( {n}_{F} - {n}_{C} )} ,$$

wherein nᵢ is the refractive index for different wavelengths, wherein n_{C} is the refractive index tor 656 nm, n_{D} is the refractive index for 589 nm and n_{F} is the refractive index for 486 nm.

Embodiment 6: The measurement head according to the preceding embodiment, wherein the ratio vₑ/n_{D} is in the range of 13.9≤vₑ/n_{D}≤44.7, more preferably in the range of 15.8≤vₑ/n_{D}≤40.1.

Embodiment 7: The measurement head according to any one of the preceding embodiments, wherein each of the optical receiving fibers comprises at least one cladding and at least one core.

Embodiment 8: The measurement head according to the preceding embodiment, wherein a product αΔn is αΔn≤110 dB/km at at least one wavelength in a visual and near infrared wavelength range, preferably at at least one wavelength selected from 656 nm, 589 nm, or 486 nm, wherein α is the attenuation coefficient and Δn is the refractive index contrast with Δn=(n₁²−n₂²)/(2n₁²), wherein n₁ is the maximum core refractive index and n₂ is the cladding refractive index.

Embodiment 9: The measurement head according to the preceding embodiment, wherein the product αΔn is αΔn≤23 dB/km, preferably αΔn≤11.26 dB/km.

Embodiment 10: The measurement head according to any one of the three preceding embodiments, wherein the product αΔn is in the range 0.0004 dB/km≤αΔn≤110 dB/km at at least one wavelength in a visual and near infrared wavelength range, preferably at at least one wavelength selected from 656 nm, 589 nm, or 486 nm, wherein a is the attenuation coefficient and Δn is the refractive index contrast with Δn=(n₁²−n₂²)/(2n₁²), wherein n₁ is the maximum core refractive index and n₂ is the cladding refractive index.

Embodiment 11: The measurement head according to the preceding embodiment, wherein the product αΔn is in the range 0.002 dB/km≤αΔn≤23 dB/km, preferably in the range 0.02 dB/km≤αΔn≤11.26 dB/km.

Embodiment 12: The measurement head according to any one of the three preceding embodiments, wherein the transfer device has an aperture area D₁ and at least one of the optical receiving fibers has a fiber core with a cross-sectional area D₂, wherein a ratio D₁/D₂ is in the range 0.54≤D₁/D₂≤5087, preferably 1.27≤D₁/D₂≤413, more preferably 2.17≤D₁/D₂≤59.2.

Embodiment 13: The measurement head according to any one of the preceding embodiments, wherein the measurement head comprises at least one spacer device, wherein the spacer device is configured for connecting the at least one transfer device and at least one of the optical receiving fibers.

Embodiment 14: The measurement head according to the preceding embodiment, wherein the spacer device comprises a solid volume Vₛ and a hollow volume Vₕ, wherein a ratio of solid volume and hollow volume Vₛ/Vₕ is in the range 0.013≤Vₛ/Vₕ≤547, preferably in the range 0.047≤Vₛ/Vₕ≤87.6, more preferably in the range 0.171≤Vₛ/Vₕ≤26.2.

Embodiment 15: The measurement head according to any one of the preceding embodiments, wherein the measurement head further comprises an illumination source for illuminating the object.

Embodiment 16: The measurement head according to the preceding embodiment, wherein the illumination source has a geometrical extent G in the range 1.5·10⁻⁷ mm²·sr≤G≤314 mm²·sr, preferable in the range 1·10⁵ mm²·sr≤G≤22 mm²·sr, more preferable in the range 3·10⁻⁴ mm²·sr≤G≤3.3 mm²·sr.

Embodiment 17: The measurement head according to the preceding embodiment, wherein the geometrical extent G of the illumination source is defined by G=A·Ω·n², wherein A is the area of the surface with A=A_{OF}=π·r²_{OF}, and Ω is the projected solid angle subtended by the light and n is the refractive index of the medium, wherein for rotationally-symmetric optical systems with a half aperture angle θ, the geometrical extend is given by G=π·A·sin²(θ) n², wherein an half aperture angle θ and/or a divergence angle θₘₐₓ is small, wherein the half aperture angle θ is in the range 0.01°≤θ≤42°; preferably in the range of 0.1°≤θ≤21°; more preferably in the range of 0.15°≤θ≤13° and/or the divergence angle θₘₐₓ is in the range 0.01°≤θₘₐₓ≤42°; preferably in the range of 0.1°≤θₘₐₓ≤21°; more preferably in the range of 0.15°≤θₘₐₓ≤13°, wherein the area A is smaller than 10 mm², preferably smaller than 3 mm², more preferably smaller than 1 mm².

Embodiment 18: The measurement head according to any one of the two preceding embodiments, wherein each optical receiving fiber comprises the at least one fiber cladding and the at least one core, wherein a ratio d₁/BL is in the range 0.0011≤d₁/BL≤513, where d₁ is the diameter of the core and BL is a baseline.

Embodiment 19: The measurement head according to the preceding embodiment, wherein the ratio d₁/BL is in the range 0.0129≤d₁/BL≤28, preferable in the range 0.185≤d₁/BL≤ and 7.1.

Embodiment 20: The measurement head according to any one of the preceding embodiments, wherein each optical receiving fiber has at least one entrance face, wherein a geometric center of the respective entrance face is aligned perpendicular with respect to an optical axis of the transfer device.

Embodiment 21: The measurement head according to any one of the preceding embodiments, wherein at least one of the optical receiving fibers is a structured fiber having a shaped and/or structured entrance and/or exit face.

Embodiment 22: The measurement head according to any one of the preceding embodiments, wherein the transfer device specifically may comprise one or more of: at least one lens, for example at least one lens selected from the group consisting of at least one focus-tunable lens, at least one aspheric lens, at least one spherical lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system; at least one gradient index (GRIN) lens.

Embodiment 23: The measurement head according to any one of the preceding embodiments, wherein the measurement head comprises at least one actuator configured to move the measurement head to scan a region of interest.

Embodiment 24: The measurement head according to the preceding embodiment, wherein the actuator comprises at least one electromechanical actuator and/or at least one piezo actuator, wherein the piezo actuator comprises at least one actuator selected from the group consisting of: at least one piezoceramic actuator; at least one piezoelectric actuator.

Embodiment 25: The measurement head according to any one of the two preceding embodiments, wherein the actuator is configured to move an optical illumination fiber of the measurement head and/or the measurement head.

Embodiment 26 The measurement head according to the preceding embodiment, wherein the actuator is adapted to move one or both of the optical illumination fiber and/or the measurement head in a linear scan and/or a radial scan and/or a spiral scan.

Embodiment 27: A kit comprising at least one measurement head according to any one of the preceding embodiments and a detector for determining a position of at least one object, the detector comprising:
at least two optical sensors, wherein each optical sensor has at least one light-sensitive area, wherein each optical sensor is designed to generate at least one sensor signal in response to an illumination of its respective light-sensitive area by a light beam having passed through at least one of the optical receiving fibers of the measurement head;
at least one evaluation device being configured for determining at least one longitudinal coordinate z of the object by evaluating a combined signal Q from the sensor signals.

Embodiment 28: The kit according to the preceding embodiment, wherein the evaluation device is configured for deriving the combined signal Q by one or more of dividing the sensor signals, dividing multiples of the sensor signals, dividing linear combinations of the sensor signals.

Embodiment 29: The kit according to the preceding embodiment, wherein the evaluation device is configured for using at least one predetermined relationship between the combined signal Q and the longitudinal coordinate for determining the longitudinal coordinate.

Embodiment 30: The kit according to any one of the preceding embodiments, wherein the evaluation device is configured for deriving the combined signal Q by

$$Q ( {z}_{o} ) = \frac{{\int \int }_{{A}_{1}} E ( x , y \text{;} {z}_{o} ) dxdy}{{\int \int }_{{A}_{2}} E ( x , y \text{;} {z}_{o} ) dxdy}$$

wherein x and y are transversal coordinates, A1 and A2 are areas of the beam profile at a sensor position of the optical sensors (113), and E(x,y,zₒ) denotes the beam profile given at the object distance zₒ.

Embodiment 31: The kit according to any one of the preceding embodiments referring to a kit, wherein each of the sensor signals comprises at least one information of at least one area of the beam profile of the light beam, wherein the beam profile is selected from the group consisting of a trapezoid beam profile; a triangle beam profile; a conical beam profile and a linear combination of Gaussian beam profiles.

Embodiment 32: The kit according to the preceding embodiment, wherein the light-sensitive areas are arranged such that a first sensor signal comprises information of a first area of the beam profiles and a second sensor signal comprises information of a second area of the beam profile, wherein the first area of the beam profile and the second area of the beam profile are one or both of adjacent or overlapping regions, wherein the evaluation device is configured to determine the first area of the beam profile and the second area of the beam profile, wherein the first area of the beam profile comprises essentially edge information of the beam profile and the second area of the beam profile comprises essentially center information of the beam profile, wherein the edge information comprises information relating to a number of photons in the first area of the beam profile and the center information comprises information relating to a number of photons in the second area of the beam profile, wherein the evaluation device is configured to derive the combined signal Q by one or more of dividing the edge information and the center information, dividing multiples of the edge information and the center information, dividing linear combinations of the edge information and the center information.

Embodiment 33: The kit according to any one of the preceding embodiments referring to a kit, wherein the optical sensors are partial diodes of a bi-cell or quadrant diode and/or comprise at least one CMOS sensor.

Embodiment 34: A method for determining a position of at least one object by using a kit according to any one of the preceding embodiments referring to a kit, the method comprising the following steps:
i) providing at least one measurement head, the measurement head comprising:
at least one transfer device, wherein the transfer device has at least one focal length in response to the at least one incident light beam propagating from the object to the measurement head;
at least two optical receiving fibers, wherein at least one of the optical receiving fibers and/or the transfer device has a ratio εᵣ/k≥0.362 (m·K)/W, wherein k is the thermal conductivity and εᵣ is the relative permittivity;
ii) providing at least one detector, the detector comprising at least two optical sensors, wherein each optical sensor has at least one light-sensitive area, wherein each optical sensor is designed to generate at least one sensor signal in response to an illumination of its respective light-sensitive area by a light beam having passed through at least one of the optical receiving fibers of the measurement head;
iii) illuminating each light-sensitive area of at least two optical sensors of the detector with at least one light beam having passed through at least one of the optical receiving fibers, wherein, thereby, each of the light-sensitive areas generates at least one sensor signal; and
iv) evaluating the sensor signals, thereby, determining at least one longitudinal coordinate z of the object, wherein the evaluating comprises deriving a combined signal Q of the sensor signals.

Embodiment 35: A use of the measurement head according to any one of the preceding embodiments relating to a measurement head, for a purpose of use, selected from the group consisting of: a position measurement in traffic technology; an entertainment application; an optical data storage application; a security application; a surveillance application; a safety application; a human-machine interface application; a logistics application; an endoscopy application; a medical application; a tracking application; a photography application; a machine vision application; a robotics application; a quality control application; a 3D printing application; an augmented reality application; a manufacturing application; a use in combination with optical data storage and readout.

### BRIEF DESCRIPTION OF THE FIGURES

Further optional details and features of the invention are evident from the description of preferred exemplary embodiments which follows in conjunction with the dependent claims. In this context, the particular features may be implemented in an isolated fashion or in combination with other features. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIGS. 1A to C show embodiments of a measurement head according to the present invention;

FIG. 2 shows an embodiment of a kit according to the present invention;

FIG. 3 shows a cross section of a fiber arrangement of the measurement head;

FIGS. 4A to MM show in top view embodiments of measurement heads;

FIGS. 5A to MM show in top view embodiments of fiber and lens arrangement of measurement heads;

FIGS. 6 A to D show side views of embodiments of fiber and lens arrangement in the measurement head;

FIGS. 7 A to F show lens arrangement at fiber ends;

FIGS. 8A to E show further embodiments of the measurement head;

FIG. 9 shows a further embodiment of the measurement head;

FIG. 10 shows a further embodiment of the measurement head; and

FIG. 11 shows an embodiment of an optical receiving fiber.

### DETAILED DESCRIPTION OF THE EMBODIMENTS

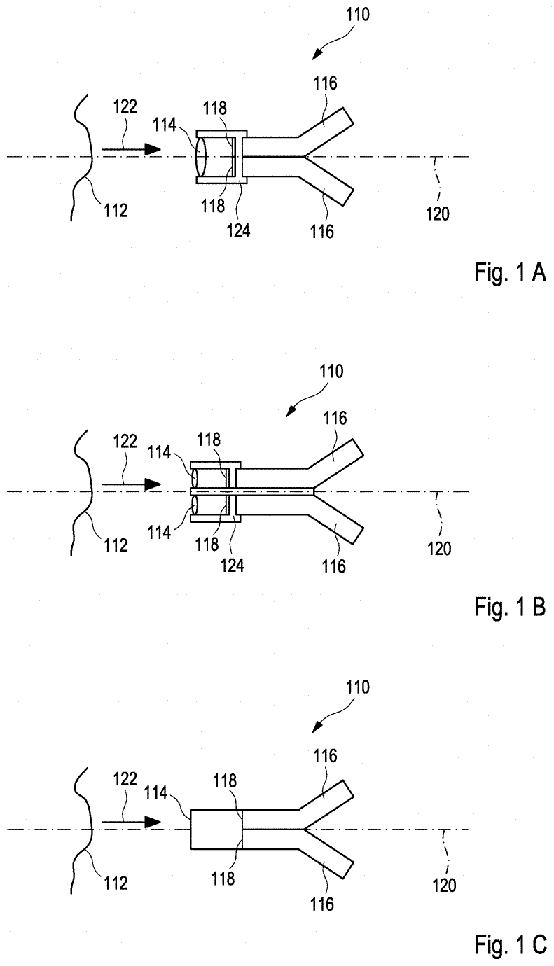

In FIGS. 1A to C, schematic views of exemplary embodiments of a measurement head 110 for determining a position of at least one object 112 are depicted. The measurement head 110 comprises at least one transfer device 114. The transfer device 114 has at least one focal length in response to the at least one incident light beam propagating from the object 112 to the measurement head 110. The measurement head 110 comprises at least two optical receiving fibers 116.

The optical receiving fibers 116 may have specific mechanical and optical properties to ensure stability of the distance measurement in a broad range of environments. The mechanical properties of the optical receiving fibers 116 may be identical or the mechanical properties of the optical receiving fibers 116 may differ. Without wishing to be bound by this theory, a light supporting function of optical receiving fibers 116 relies on relationships of refractive indices and certain energy transport properties. Further certain mechanical parameters may be prerequisite that all functions of the optical receiving fibers 116 are maintained in a stable way. Therefore, certain mechanical parameters may act as prerequisite to ensure a stable measurement itself. At least one of the optical receiving fibers and/or the transfer device has a ratio εᵣ/k≥0.362 (m·K)/W. Preferably, at least one of the optical receiving fibers and/or the transfer device has the ratio εᵣ/k≥0.743 (m·K)/W, preferably the ratio is εᵣ/k≥1.133 (m·K)/W. At least one of the optical receiving fibers 116 and/or the transfer device 114 has the ratio εᵣ/k in the range 0.362 (m·K)/W≤εᵣ/k≤1854 (m·K)/W, wherein k is the thermal conductivity and εᵣ is the relative permittivity. The relative permittivity is also known as the dielectric constant. Preferably, the ratio εᵣ/k is in the range 0.743 (m·K)/W≤εᵣ/k≤194 (m·K)/W. More preferably, the ratio εᵣ/k is in the range 1.133 (m·K)/W≤εᵣ/k≤88.7 (m·K)/W. At least one of the optical receiving fibers 116 and/or the transfer device 114 may have a relative permittivity in the range 1.02≤εᵣ≤18.5, preferably in the range 1.02≤εᵣ≤14.5, more preferably in the range 1.02≤εᵣ≤8.7, wherein the relative permittivity is measured at 20° C. and 1 kHz. The optical receiving fibers 116 and/or the transfer device 114 may have a thermal conductivity of k≤24 (m·K)/W, preferably k≤17 (m·K)/W, more preferably k≤14 (m·K)/W. The optical receiving fibers 116 and/or the transfer device 114 may have a thermal conductivity of k≥0.003 (m·K)/W, preferably k≤0.007 (m·K)/W, more preferably k≤0.014 (m·K)/W. The thermal conductivity may be measured at 0° C. and <1% relative humidity. The transfer device 114 may have a ratio vₑ/n_{D} in the range 9.05≤vₑ/n_{D}≤77.3, wherein vₑ is the Abbé-number and n_{D} is the refractive index. The Abbé-number vₑ is given by

$${v}_{e} = \frac{( {n}_{D} - 1 )}{( {n}_{F} - {n}_{C} )} ,$$

wherein nᵢ is the refractive index for different wavelengths, wherein n_{C} is the refractive index for 656 nm, n_{D} is the refractive index for 589 nm and n_{F} is the refractive index for 486 nm, measured at room temperature, see e.g. https://en.wikipedia.org/wiki/Abbe_number. Preferably, the ratio vₑ/n_{D} is in the range of 13.9≤vₑ/n_{D}≤44.7, more preferably in the range of 15.8≤vₑ/n_{D}≤40.1.

Each of the optical receiving fibers 116 may comprise the at least one cladding 168 and the at least one core 166. A product αΔn may be in the range 0.0004 dB/km≤αΔn≤110 dB/km at at least one wavelength in a visual and near infrared wavelength range, preferably at at least one wavelength selected from 656 nm, 589 nm, or 486 nm, wherein a the attenuation coefficient and Δn is the refractive index contrast with Δn=(n₁²−n₂²)/(2n₁²), wherein n₁ is the maximum core refractive index and n₂ is the cladding refractive index. Preferably, the product αΔn is in the range 0.002 dB/km≤αΔn≤23 dB/km, more preferably in the range 0.02 dB/km≤αΔn≤11.26 dB/km. The refractive index contrast Δn may be in the range 0.0015≤Δn≤0.285, preferably in the range 0.002≤Δn≤0.2750, more preferably in the range 0.003≤Δn≤0.25. The attenuation coefficient of the optical receiving fiber 116 may be in the range 0.2 dB/km≤α≤420 dB/km, preferably in the range 0.25 dB/km≤α≤320 dB/km. The transfer device 114 may have an aperture area D₁ and at least one of the optical receiving fibers may have the fiber core 166 with a cross-sectional area D₂, wherein a ratio D₁/D₂ is in the range 0.54≤D₁/D₂≤5087, preferably 1.27≤D₁/D₂≤413, more preferably 2.17≤D₁/D₂≤59.2. A diameter d_{core} of the core 166 of at least one of the optical receiving fibers may be in the range 2.5 μm≤d_{core}≤10000 μm, preferably in the range 7 μm≤d_{core}≤3000 μm, more preferably in the range 10 μm≤d_{core}≤500 μm.

The optical receiving fibers 116 and/or the transfer device 114 may have a Youngs modulus, also denoted elastic modulus, of less or equal 188 GPa, measured at room temperature, for example by using ultrasonic testing. Preferably the optical receiving fibers 116 and/or the transfer device 114 may have a Youngs modulus of less or equal 167 GPa, more preferably in the range from to 0.0001 GPa to 97 GPa. The optical receiving fibers 116 and/or the transfer device 114 may have a Youngs modulus of greater or equal 0.0001 GPa, preferably of greater or equal 0.007 GPa, more preferably of greater or equal 0.053 GPa.

Each of the optical receiving fibers 116 may have at least one entrance face 118. A geometric center of the respective entrance face 118 may be aligned perpendicular with respect to an optical axis 120 of the transfer device 114. At least one of the optical receiving fibers 116 may have an entrance face 118 which is oriented towards the object 112. The optical receiving fibers 116 may be arranged in a direction of propagation of an incident light beam 122 propagating from the object 112 to the measurement head 1120 behind the transfer device 114. The optical receiving fibers 116 and the transfer device 114 may be arranged such that the light beam 122 passes through the transfer device 114 before impinging on the optical receiving fibers 116.

As shown in FIGS. 1A and 1B, the measurement head 110 may comprise at least one spacer device 124. The spacer device 123 may be configured for connecting the at least one transfer device 114 and at least one of the optical receiving fibers 116. FIG. 1A shows an embodiment, wherein the measurement head 110 comprises one transfer device 114, such as a lens, and two optical receiving fibers 116. The spacer device may be configured to attach the transfer device 114 to both of the optical receiving fibers 116. FIG. 1B shows an embodiment, wherein the measurement head 110 comprises two transfer devices 114, such as two lenses, and two optical receiving fibers 116. The spacer device 124 may be configured for connecting each of the transfer devices 114 with one of the optical receiving fibers 116. The spacer device 124 may comprise a solid volume Vₛ and a hollow volume Vₕ. The solid volume may be defined by the volume of solid material of which the spacer device 124 consists of. The convex hull volume of the spacer device may be defined as the volume of the smallest convex hull of the solid volume of the spacer device. The hollow volume of the spacer device may be defined as the convex hull volume of the spacer device minus the solid volume of the spacer device. For example, the empty volume may be defined by inner edges of the solid material. A ratio of solid volume and hollow volume Vₛ/Vₕ may be in the range 0.013≤Vₛ/Vₕ≤547, preferably in the range 0.047≤Vₛ/Vₕ≤87.6, more preferably in the range 0.171≤Vₛ/Vₕ≤26.2.

In the embodiment of FIG. 1C, the transfer device 114 may comprise at least one gradient index (GRIN) lens 114. The transfer device 114 and the optical receiving fibers 116 may be configured as one-piece. The optical receiving fibers 116 may be attached to the transfer device 114 such as by a polymer or glue or the like, to reduce reflections at interfaces with larger differences in refractive index.

The optical receiving fibers 116 may be arranged as such, that the light beam 122 impinges on the optical receiving fibers 116 between the transfer device 114 and the focal point of the transfer device 114. For example, a distance in a direction parallel to the optical axis 120 between the transfer device 114 and the position where the light beam 122 impinges on the optical receiving fibers 116 may be at least 20% of the focal length, more preferably at least 50% of the focal length, most preferably at least 80% of the focal length. For example, the distance in a direction parallel to the optical axis 120 between the entrance face 118 at least one of the optical receiving fibers 116 receiving the light beam 122 and the transfer device 114 may be at least 20% of the focal length, more preferably at least 50% of the focal length, most preferably at least 80% of the focal length.

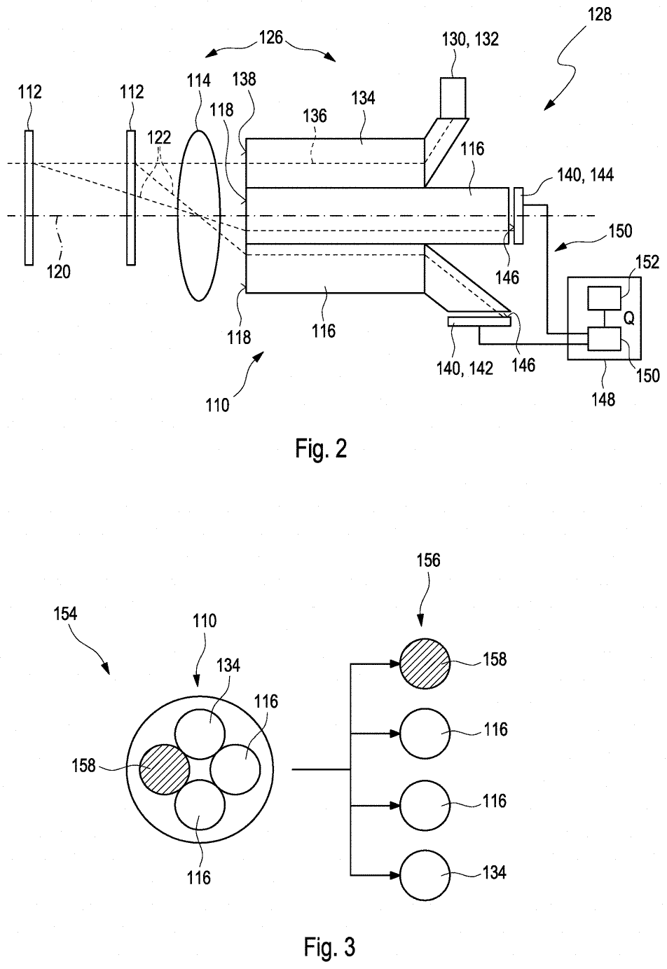

In FIG. 2, a schematic view of an exemplary embodiment of a kit 126 comprising the measurement head 110 and a detector 128 for determining a position of at least one object 112 is depicted. In this embodiment, the measurement head 110 comprises the transfer device 114 and two optical receiving fibers 116. For further description of the measurement head 110 reference is made to the description of FIGS. 1A to C. In addition, the measurement head 110 may comprise at least one illumination source 130 for illuminating the object 112. As an example, the illumination source 130 may be configured for generating an illuminating light beam for illuminating the object 112. Specifically, the illumination source 130 may comprise at least one light source 132 such as at least one laser and/or laser source. Various types of lasers may be employed, such as semiconductor lasers. Additionally or alternatively, non-laser light sources may be used, such as LEDs and/or light bulbs. The illumination source 130 may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the illumination source 130 may have a wavelength of 300 to 1000 nm, especially 500 to 1000 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1000 nm may be used. Further, the illumination source 130 may be configured for emitting modulated or non-modulated light. In case a plurality of illumination sources 130 is used, the different illumination sources may have different modulation frequencies which, later on may be used for distinguishing the light beams. The illumination source 130 may comprise at least one optical illumination fiber 134 adapted to transmit a light beam 136 generated by the light source 132 such that it illuminates the object 112. The light beam 136 may leave the optical illumination fiber 134 at an exit face 138 of the optical illumination fiber 134.

In FIG. 2, the object 112 is depicted for two different object distances. The detector 128 comprises at least two optical sensors 140, for example a first optical sensor 142 and a second optical sensor 144, each having at least one light-sensitive area 146.

The first optical sensor 142, in response to the illumination by the light beam 122, may generate a first sensor signal s₁, whereas the second optical sensor 144 may generate a second sensor signal s₂. Preferably, the optical sensors 140 are linear optical sensors. The sensor signals s₁ and s₂ are provided to an evaluation device 148 of the detector 128. The evaluation device 148 is embodied to derive a combined signal Q from the sensor signal, specifically by evaluating a quotient signal. From the combined signal Q, derived by dividing the sensor signals s₁ and s₂ or multiples or linear combinations thereof, may be used for deriving at least one item of information on a longitudinal coordinate z of the object 112. The evaluation device 148 may have at least one divider 150 for forming the combined signal Q, and, as an example, at least one position evaluation device 152, for deriving the at least one longitudinal coordinate z from the combined signal Q. It shall be noted that the evaluation device 148 may fully or partially be embodied in hardware and/or software. Thus, as an example, one or more of components 150, 152 may be embodied by appropriate software components.

The illumination source 130 may have a geometrical extend G in the range 1.5·10⁻⁷ mm²·sr≤G≤314 mm²·sr, preferable in the range 1·10⁵ mm²·sr≤G≤22 mm²·sr, more preferable in the range 3·10⁻⁴ mm²·sr≤G≤3.3 mm²·sr. The geometrical extent G of the illumination source 130 may be defined by

G=A·Ω·n²,

wherein A is the area of the surface, which can be an active emitting surface, a light valve, optical aperture or the area of the fiber core 166 with A=A_{OF}=π·r²_{OF}, and f is the projected solid angle subtended by the light and n is the refractive index of the medium. For rotationally-symmetric optical systems with a half aperture angle θ, the geometrical extend is given by

G=π·A·sin²(θ)n².

For optical receiving fibers a divergence angle is obtained by θₘₐₓ=arcsin(NA/n), where NA is the maximum numerical aperture of the optical receiving fiber.

The half aperture angle θ and/or the divergence angle θₘₐₓ may be small. In particular, the half aperture angle θ may be in the range 0.01°≤42°; preferably in the range of 0.1°≤θ≤21°; more preferably in the range of 0.15°≤θ≤13° and/or the divergence angle θₘₐₓ be in the range 0.01°≤θₘₐₓ≤42°; preferably in the range of 0.1°≤θₘₐₓ≤21°; more preferably in the range of 0.15°≤θₘₐₓ≤13° The area A may be small. In particular, the area A may be smaller than 10 mm², preferably smaller than 3 mm², more preferably smaller than 1 mm².

The measurement head 110 may comprise a small baseline. Each optical receiving fiber 116 comprises the at least one fiber cladding 168 and the at least one core 166. A ratio d₁/BL may be in the range 0.0011≤d₁/BL≤513, where d₁ is the diameter of the core 166 and BL is the baseline. Preferably, the ratio d₁/BL is in the range 0.0129≤d₁/BL≤28, more preferable in the range 0.185≤d₁/BL≤ and 7.1. The baseline may have an extend greater than 0. The baseline may be in the range 10 μm≤BL≤127000 μm, preferably in the range 100 μm≤BL≤76200 μm, more preferably in the range 500 μm≤BL≤25400 μm.

The measurement head 110 may comprise at least two or more fibers. The optical receiving fibers 116 may be at least one multifurcated optical receiving fiber, in particular at least one bifurcated optical receiving fiber. In the cut through in FIG. 3, an exemplary embodiment is shown wherein the measurement head 110 may comprise four fibers. In particular the optical receiving fiber may comprise the optical illumination fiber 134 and two optical receiving fibers 116. As shown schematically in FIG. 3, the optical receiving fibers 116 may be arranged close to each other at an entrance end 154 of the measurement head 110 and may split into legs separated by a distance at an exit end 156 of the measurement head 110. The optical receiving fibers 116 may be designed as fibers having identical properties or may be fibers of different type. The measurement head 110 may comprise more than three fibers, for example four fibers as depicted in FIG. 3, wherein a fourth fiber 158 can be a further fiber 116.

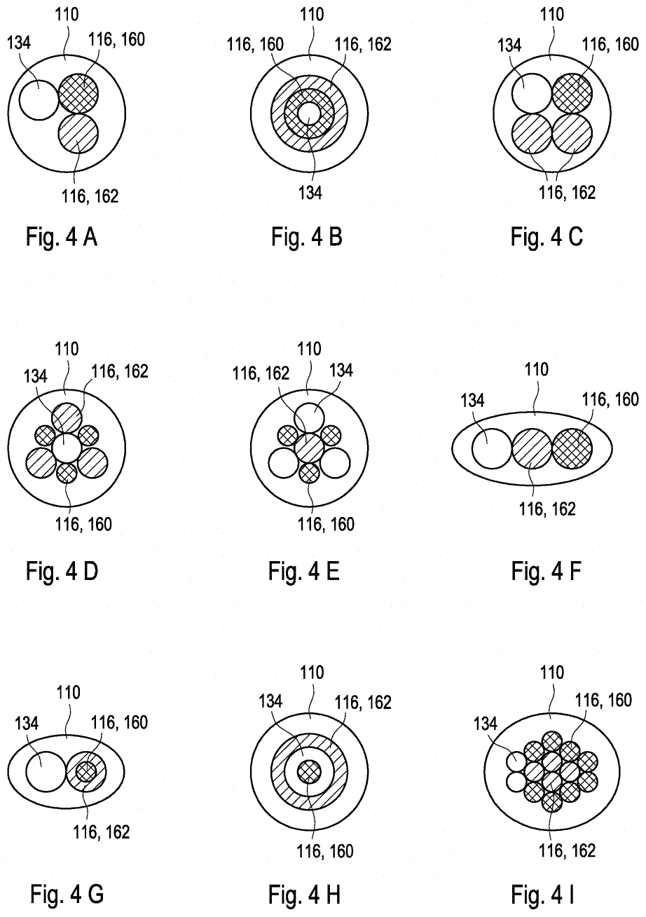

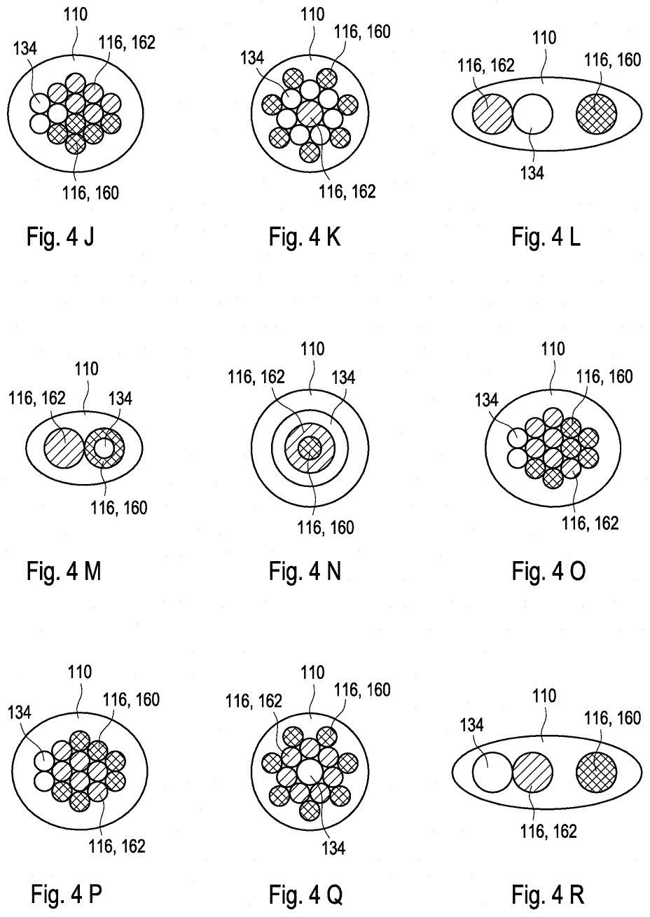

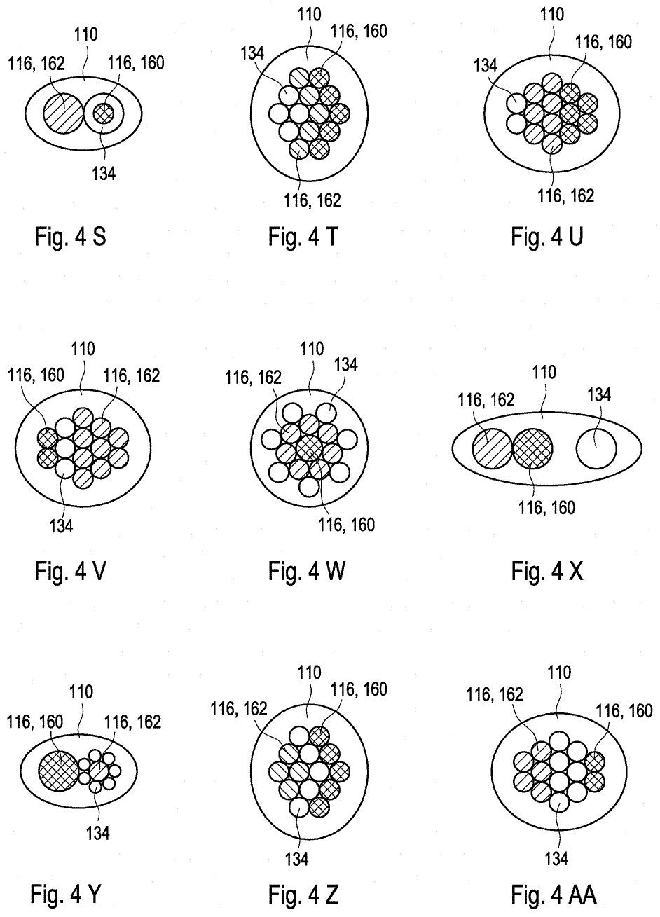

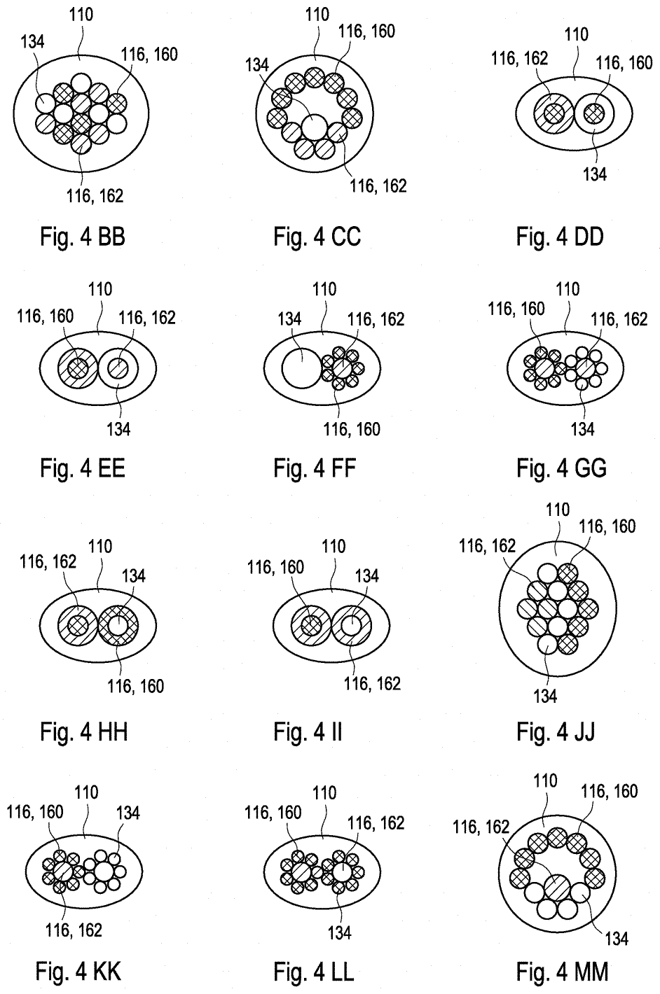

FIGS. 4A to 4MM show in top view embodiments of measurement heads 110. The measurement head 110 may comprise at least one spacer device 124, for example at least one metal housing and/or plastic housing. Each of the measurement heads 110 may comprise a plurality of fibers, specifically a plurality of the at least one optical illumination fiber 134 and/or the at least one optical receiving fiber 116. In particular, FIGS. 4 A, B, F, G, H, L, R, M, N, R, S, X show embodiments of measurement heads 110 having one optical illumination fiber 134 and two optical receiving fibers 116, specifically a first optical receiving fiber 160 adapted to provide the light beam to the first optical sensor 142, and a second optical receiving fiber 162 adapted to provide the light beam 122 to the second optical sensor 144. The measurement head 110 may comprise at least one radially arranged or radially symmetric design. For example, at least two elements selected from the group consisting of: the first optical receiving fiber 160; the second optical receiving fiber 162; or the optical illumination fiber 134 may be arranged concentric and having and/or sharing a common central axis. For example, as shown in FIGS. 4 B, H and N, the first optical receiving fiber 160, the second optical receiving fiber 162 and the optical illumination fiber 134 may be arranged concentric and having and/or sharing a common central axis. Other embodiments of a radially arranged or radially symmetric design are possible. For example, as shown in FIGS. 4 GG, KK and LL a plurality of at least one element selected from the group consisting of: the first optical receiving fiber 160; the second optical receiving fiber 162; or the optical illumination fiber 134 may be arranged radially around at least one other element selected from the group consisting of: the first optical receiving fiber 160; the second optical receiving fiber 162; or the optical illumination fiber 134. The radially arranged or radially symmetric design may allow enhancing robustness of measurement values, in particular at strong black-and-white contrast in a measured point of the object or for measurements of concave or convex surfaces. FIGS. 4 C, D, E, I, J, K, O, P, Q, T, U, V, W, Y, Z and AA to MM show further possible arrangements of different numbers of optical illumination fibers 134, first optical receiving fibers 160 and second optical receiving fibers 162 within the measurement head 110. Other arrangements of the fibers within the measurement head 110 are thinkable.

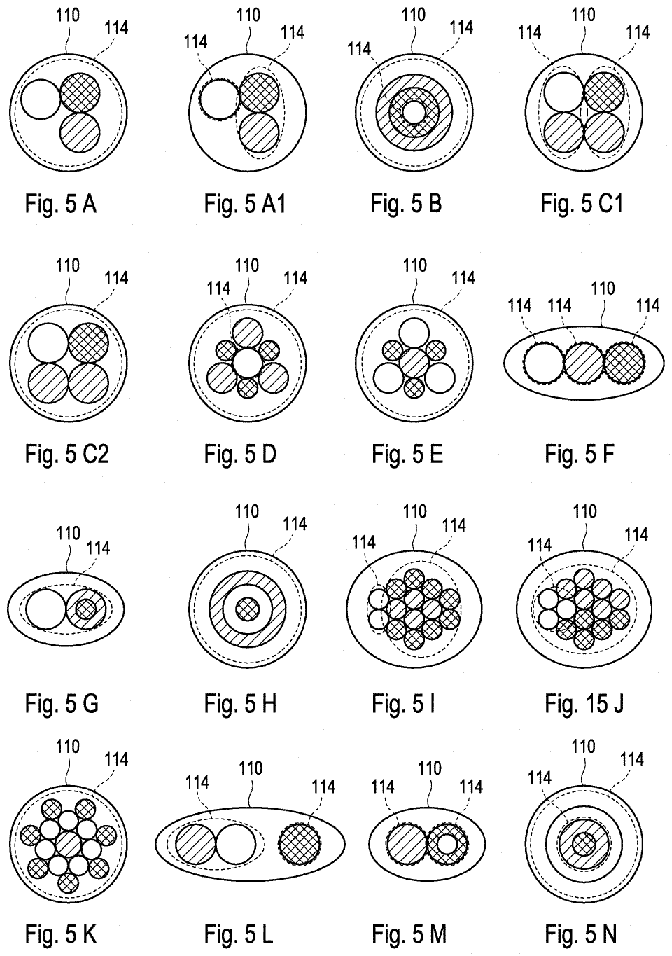

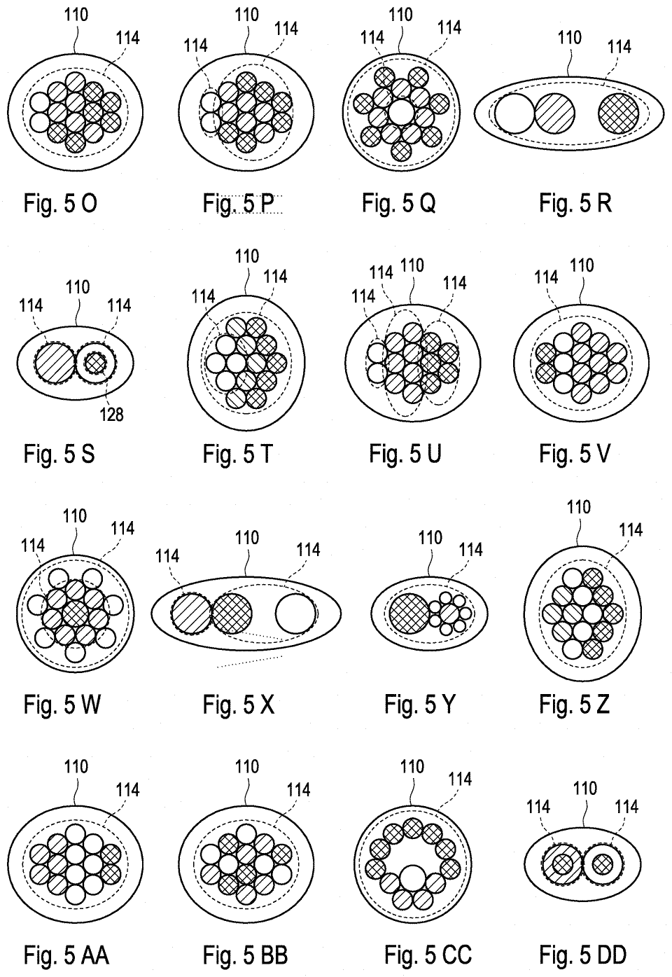

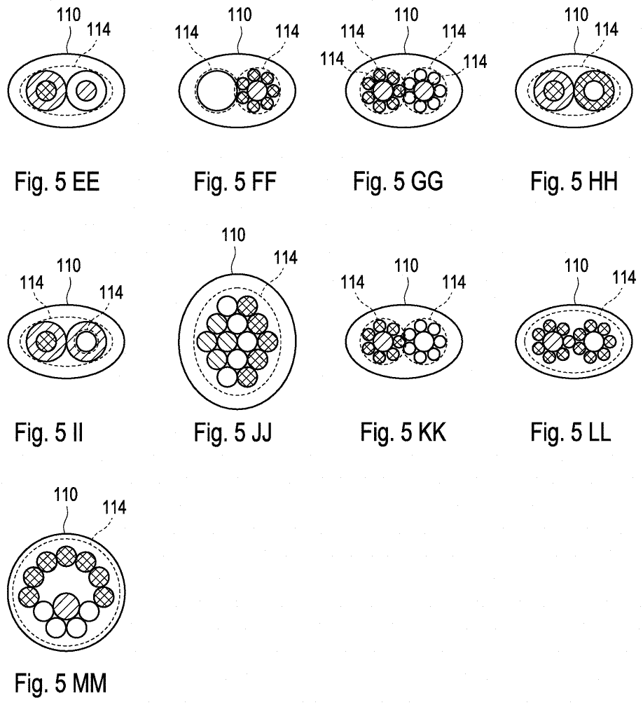

The measurement head 110 comprises one or more transfer devices 114, in particular collimating lenses. FIG. 5 A to MM show in top view embodiments of lens arrangements in measurement heads 110. The arrangement of fibers in the measurement heads 110 of FIGS. 5 A to MM correspond to the arrangement shown in FIGS. 4 A to MM, wherein in FIG. 5 A and A1, C1 and C2 two embodiments for the fiber arrangement of FIGS. 4 A and C, respectively, are shown. For clarity reference numbers of respective fibers were omitted such that reference is made to FIGS. 4 A to MM. The measurement heads 110 shown in FIGS. 5 A, AA, BB, C2, E, EE, H, HH, JJ, K, M, MM, O, R, V, Y, Z comprise one transfer device 114 arranged in front of all fibers. FIGS. 5 A1, C1, DD, F, FF, G, I, KK, L, P, U, X show measurement heads 110 comprising two or more transfer devices 114 in front of the fibers. FIGS. 5 B, D, CC, GG, II, J, N, LL, S, T, W, Q show measurement heads 110 comprising at least one separate lens 114 for fibers having the same function. For example, in FIGS. 5 B, CC, D, II, J, LL, T and Q, the measurement head 110 comprises transfer device 114 covering all fibers and a separated lens 114 covering optical illumination fibers 134 only in addition. For example, in FIG. 5 GG, the measurement head 110 comprises two transfer devices 114. A first transfer device 114 may cover a optical illumination fiber 134 and a plurality of first optical receiving fibers 160, which are arranged radially around the first optical illumination fiber 134, and a second transfer device 114 may cover an optical illumination fiber 134 and a plurality of second optical receiving fibers 162, which are arranged radially around one second optical illumination fiber 134. Furthermore, in FIG. 5 GG two separated transfer devices 114 are shown which cover the illumination fibers 134 only and in addition. For example, FIG. 5 N shows an embodiment, wherein a first transfer device 114 may cover all optical fibers, a second separate transfer device 114 may cover the first optical receiving fiber 160 and the second optical receiving fiber 162 and a third separate transfer device 114 may cover the first optical receiving fiber 160 only. For example, FIG. 5 S shows an embodiment having three transfer devices 114: a first transfer device 114 covering only the second optical receiving fiber 162, a second transfer device 114 covering both of the first optical receiving fiber 160 and the optical illumination fiber 134 and a third transfer device 114 covering the first optical receiving fiber 160 only. For example, FIG. 5 W shows a measurement head 110 comprising two transfer devices 114; a first transfer device 114 covering all fibers and at least one separate lens 114 covering the first optical receiving fiber 160 and the second optical receiving fiber 162. The optical paths of the first measurement fiber and/or the second measurement fiber and/or the illumination fiber and/or the optical pathways of two or more transfer devices may be fully or partially optically separated by mechanical means such as parts of the spacer device and/or a fully or partially intransparent mechanical wall or cladding or the like to avoid internal reflections.

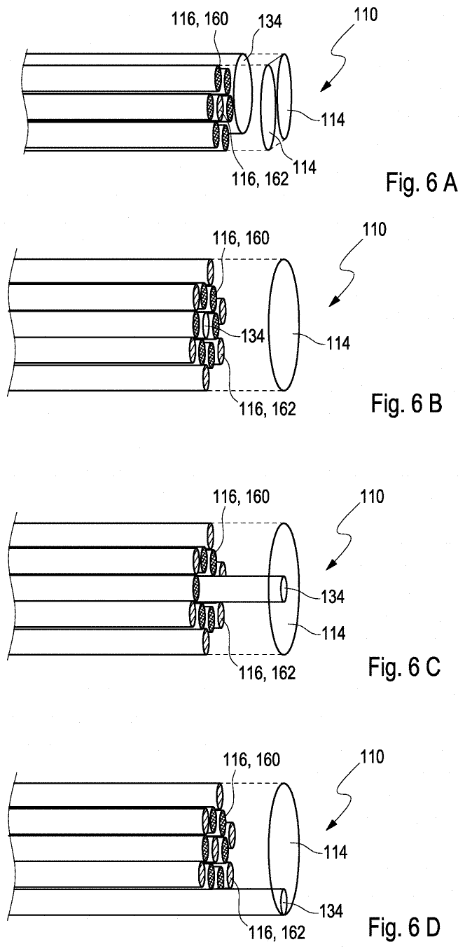

FIGS. 6 a to D show a side view of embodiments of fiber and lens arrangement in the measurement head 110. FIG. 6A corresponds to the fiber and lens arrangement depicted in FIGS. 4 FF and 5 FF. The measurement head 110 may comprise separate transfer devices for optical illumination fiber 134 and optical receiving fibers 116, i.e. the at least one first optical receiving fiber 160 and the at least one second optical receiving fiber 162. The measurement head 110 may comprise one optical illumination fiber 134. The measurement head 110 may comprise, in particular displaced from the optical illumination fiber 134, one second optical receiving fiber 162 which is surrounded by six first optical receiving fibers 160 which are arranged radial around the second optical receiving fiber 162. The measurement head 110 may comprise a first transfer device 114, which may be arranged in front of the optical illumination fiber 134, and a second transfer device 114 which may cover the first optical receiving fiber 160 and the second optical receiving fiber 162.

FIG. 6 B to D show embodiments of the measurement head 110 comprising one optical illumination fiber 134, six first optical receiving fiber 160 and six second optical receiving fibers 162. In FIG. 6 B an arrangement is shown wherein the optical illumination fiber 134 is arranged in a center which is radially surrounded by the six first optical receiving fibers 160. The first optical receiving fibers 160 may be surrounded radially by the six second optical receiving fibers 162. The measurement head 110 may comprise one transfer device 114 for the optical illumination fiber 134 and the receiving fibers. Internal reflections may be generated at the transfer device which may generate a signal offset to the receiving fibers. FIG. 6 B shows an embodiment of a radial arrangement without a baseline. In FIG. 6 C, a similar fiber arrangement is shown, but the measurement head 110 may comprise separate transfer devices 114 for the optical illumination fiber 134 and the receiving fibers. In this embodiment, the optical illumination fiber 134 may be guided up to the transfer device 114 such that internal reflections can be prevented. This embodiment shows a radial arrangement without a baseline. FIG. 6 D shows a fiber arrangement wherein the optical illumination fiber 134 is arranged displaced from the center of the arrangement. In this embodiment, the optical illumination fiber 134 may be guided up to the transfer device 114 such that internal reflections can be prevented.

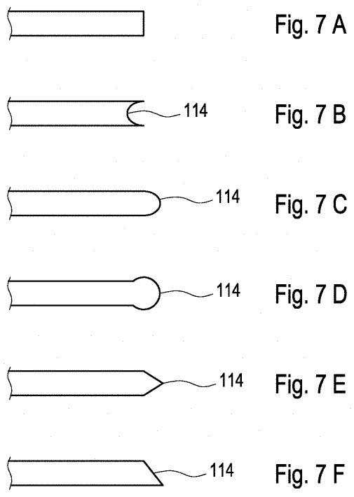

FIGS. 7 A to F show different lens arrangements at the fiber ends. As described above, at least one transfer device 114 may be arranged at an end of the optical fibers. The transfer device 114 may be attached directly to one optical fiber or may be attached to a bundle of optical fibers. Alternatively, the transfer device 114 may be attached to the optical fiber or bundle of optical fibers using at least one spacer device 124. FIG. 7 A shows an optical fiber or a bundle of optical fibers. FIG. 7 B shows the optical fiber or bundle of optical fibers having attached at least one concave lens. FIG. 7 C shows the optical fiber or bundle of optical fibers having attached at least one convex lens. FIG. 7 D shows the optical fiber or bundle of optical fibers having attached at least one spherical lens. FIG. 7 E shows the optical fiber or bundle of optical fibers having attached at least one conical lens or at least one tip-shaped lens. FIG. 7 F shows the optical fiber or bundle of optical fibers having attached at least one prism shaped lens, in particular a non-rotationally symmetric lens.

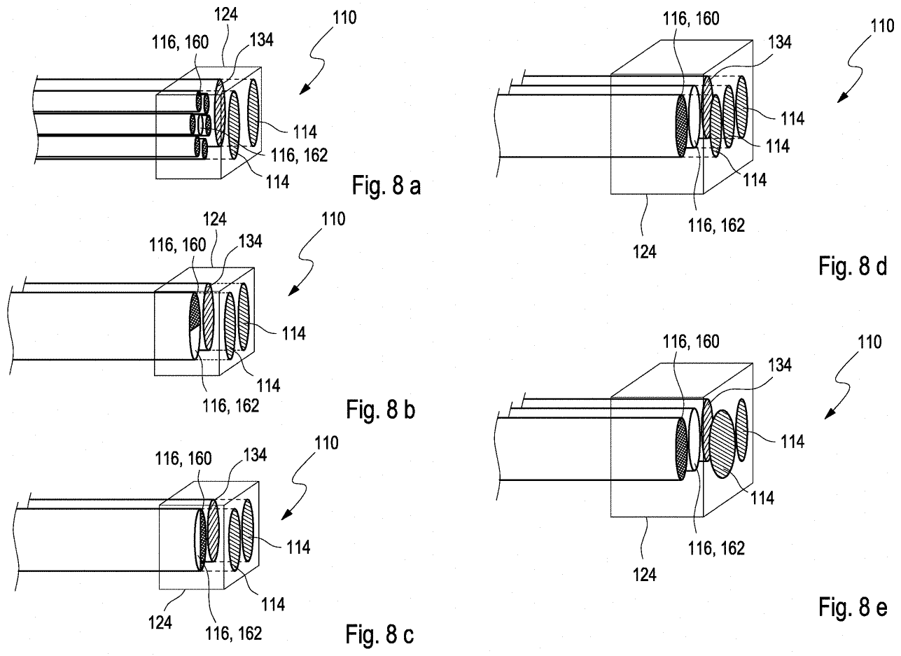

FIGS. 8A to E show further embodiments of the measurement head 110. The lens and fiber arrangement in FIG. 8A corresponds to the lens and fiber arrangement as shown in FIG. 6 A. In FIG. 8A, in addition the measurement head 110 comprises the spacer device 124 which is adapted to attach the transfer devices 114 to the optical receiving fibers 116. The optical paths of the first measurement fiber 160 and/or the second measurement fiber 162 and/or the illumination fiber 134 and/or the optical pathways of two or more transfer devices 114 may be fully or partially optically separated by mechanical means such as a fully or partially intransparent mechanical wall or cladding or the like to avoid internal reflections. This optical separation by mechanical means may be part of the spacer device 124. In FIG. 8B an arrangement comprising three fibers is shown. The illumination fiber 134 may be arranged separately and parallel to the optical receiving fibers 116. The optical receiving fibers 116 may be arranged in one combined receiving fiber entrance end. A first transfer device 114 may be arranged in front of the combined receiving fiber entrance end of the optical receiving fibers 116 and a second transfer device 114 may be arranged in front of the exit end of the illumination fiber 134. The combined receiving fiber entrance end may be split up into the first measurement fiber 160 and the second measurement fiber 162. For example, in a cross sectional view the first measurement fiber 160 and the second measurement fiber may be arranged within the combined receiving fiber entrance end as half circles separated by a horizontal border. FIG. 8C shows a similar arrangement but in the embodiment of FIG. 8C, the first measurement fiber 160 and the second measurement fiber may be arranged within the combined receiving fiber entrance end as half circles separated by a vertical border. FIG. 8D shows an arrangement wherein the first measurement fiber 160 and the second measurement fiber 162 and the illumination fiber 134 each are designed as separated fibers. A first transfer device 114 may be arranged in front of the entrance end of the first measurement fiber 160 and a second transfer device 114 may be arranged in front of the entrance end of the second measurement fiber 162 and a third transfer device 114 may be arranged in front of the exit end of the illumination fiber 134. The entrance ends of the optical receiving fibers 116 and the exit end of the illumination fiber 134 may be arranged in the same plane such as plane-parallel. The transfer devices 114 may be arranged plane-parallel but in a different plane compared to the plane of the entrance ends of the optical receiving fibers 116 and the exit end of the illumination fiber 134 such spaced apart from the plane of the entrance ends of the optical receiving fibers 116 and the exit end of the illumination fiber 134. The plane of the entrance ends of the optical receiving fibers 116 and the exit end of the illumination fiber 134 and the plane of the transfer devices 114 may be parallel planes. The centers of the exit end of the illumination fiber 134 and the entrance ends of the optical receiving fibers 116 may be at the intersection of a first plane which is the plane of the entrance faces of the optical receiving fibers 116 and the exit end of the illumination fiber 134 with a second plane that is orthogonal to the first plane and contains the line connecting the centers of the exit end of the illumination fiber 134 and the entrance ends of the optical receiving fibers 116. In FIG. 8E, as in FIG. 8D, the first measurement fiber 160 and the second measurement fiber 162 and the illumination fiber 134 are designed as separated fibers. In this embodiment, a first transfer device 114 may be arranged in front of the entrance end of the optical receiving fibers 116 and a second transfer device 114 may be arranged in front of the exit end of the illumination fiber 134. As in FIG. 8D, the entrance ends of the optical receiving fibers 116 and the exit end of the illumination fiber 134 may be arranged in the same plane. The first transfer device 114 and/or the second transfer device 114 may be arranged non-parallel such as under an angle with respect to the plane of the plane of the entrance ends of the optical receiving fibers 116 and the exit end of the illumination fiber 134.

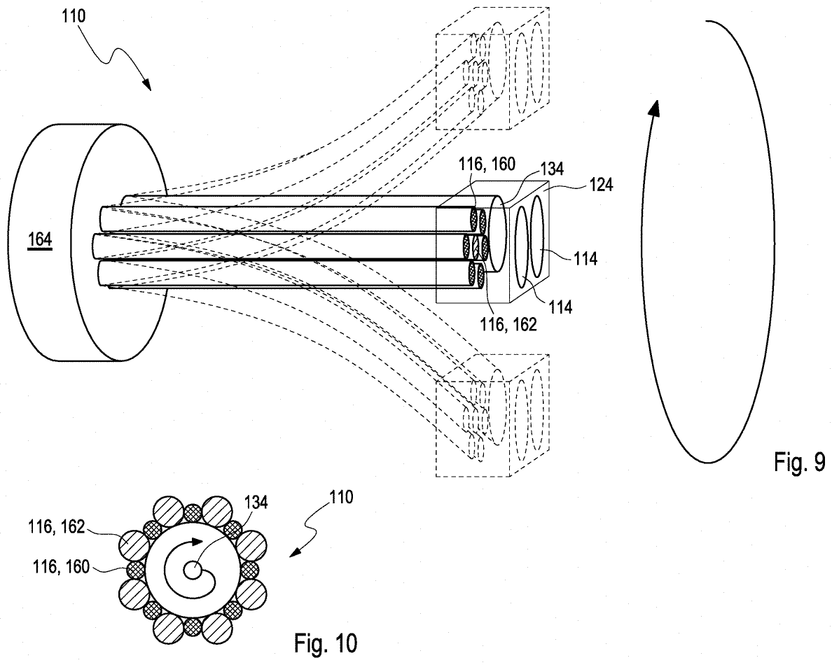

FIG. 9 shows a further embodiment of the measurement head 110 for determining a depth profile of a scenery. In FIG. 9 an embodiment is shown, wherein the measurement head 110 comprises one second optical receiving fiber 162 and six first optical receiving fibers 160 which are arranged around the second optical receiving fiber 162. Specifically, each of the optical receiving fibers 116 may have at least two ends, a distal end, also denoted as exit-end, and at least one proximal end, also denoted as receiving end. The proximal end may be arranged within and/or attached to the measurement head 110. The respective proximal end may be adapted to couple the light beam 122 into the respective optical receiving fiber 116. The distal end may be arranged closer to the optical sensors 140 and may be arranged such that the light beam travelling from the proximal end to the distal end through the optical receiving fibers 116 leaves the optical receiving fibers 116 at the distal end and illuminates the respective optical sensor 140.

The measurement head 110 further may comprise the at least one transfer device 114. The transfer device 114 may be arranged in front of the optical receiving fibers 116. The transfer device 114 may be adapted to focus the light beam 122 on the proximal end. For example, the transfer device 114 may comprise at least one element selected from the group consisting of: at least one concave lens; at least one convex lens; at least one spherical lens; at least one tip-shaped lens; at least one prism shaped lens, in particular a non-rotationally symmetric lens. In addition, the measurement head 110 may comprise at least one spacer device 124 which is adapted to attach the transfer devices 114 to the optical receiving fibers 116. Optical paths of the first measurement fiber 160 and the second measurement fiber 162 may be fully or partially optically separated by mechanical means such as a fully or partially intransparent mechanical wall or cladding or the like to avoid internal reflections. This optical separation by mechanical means may be part of the spacer device 124.

The measurement head 110 may comprise the at least one optical illumination fiber 134. The optical illumination fiber 134 may comprise at least one first end adapted to receive the at least one light beam and at least one second end from where the at least one light beam leaves the optical illumination fiber 134 for illumination of the object 112. At least the second end of the optical illumination fiber 134 may be arranged within and/or may be attached to the measurement head 110. The optical illumination fiber 134 may be arranged parallel to the direction of expansion of the optical receiving fibers 116, for example, in a bundle with the optical receiving fibers 116. The detector may comprise the at least one further transfer device 110 which may be arranged in front of the optical illumination fibers 134.

The measurement head 110 may comprise at least one actuator 164 configured to move the measurement head 110 to scan a region of interest. Specifically, the actuator 164 may be attached and/or coupled and/or connected to the optical receiving fibers 116 and/or the optical illumination fiber 134 and may be adapted to generate a force causing the optical receiving fibers 116 and/or the optical illumination fibers 134 to move, in particular to oscillate. Thus, by driving the optical receiving fiber 116 and/or the optical illumination fiber 134 the measurement head 110 moves. The actuator 164 may be adapted to generate a force corresponding to a harmonic of a natural resonant frequency of the optical receiving fibers 116 and/or the optical illumination fiber 134. The actuator 164 may comprise at least one electromechanical actuator and/or at least one piezo actuator. The piezo actuator may comprise at least one actuator selected from the group consisting of: at least one piezoceramic actuator; at least one piezoelectric actuator. The actuator 164 may be configured to cause the measurement head 110, specifically the optical illumination fiber 134 and/or the optical receiving fibers 116 to oscillate. The actuator 164 may be adapted to move the measurement head 110 in a linear scan and/or a radial scan and/or a spiral scan. In FIG. 9, an exemplary movement of the measurement head 110 is shown. For example, the actuator 164 may be adapted to generate a force on the optical receiving fibers 116 such that the measurement head 110 moves upwards and downwards. For example, the actuator 164 may be configured to generate a force on the optical receiving fibers 116 such that the measurement head 110 moves in an orbit with a predefined radius. The radius may be adjustable. For example, the actuator 164 may be adapted to generate a force such that the measurement head 110 moves in a spiral such as with a radius which alternately decreases or increases.

FIG. 10 shows a further embodiment of the measurement head 110. FIG. 10 shows a front view of the measurement head 110. In this embodiment, the measurement head 110 may comprise a plurality of first measurement fibers 160 and a plurality of second measurement fibers 162 radially arranged around the optical illumination fiber 134. The optical illumination fiber 134 may be movable by the actuator 164. The optical illumination fiber 134 may be adapted to perform a spiral movement and/or a circular movement relative to the first measurement fibers 160 and the second measurement fibers 162 and thus, allow for a spiral or circular scan. The evaluation device 158 may be adapted to calibrate the position of the optical illumination fiber 134 and to evaluate a distance from the combined signal Q depending on the position of the optical illumination fiber 134. The measurement head 110 may comprise the at least one further transfer device 114 which may be arranged in front of the optical receiving fibers 116.

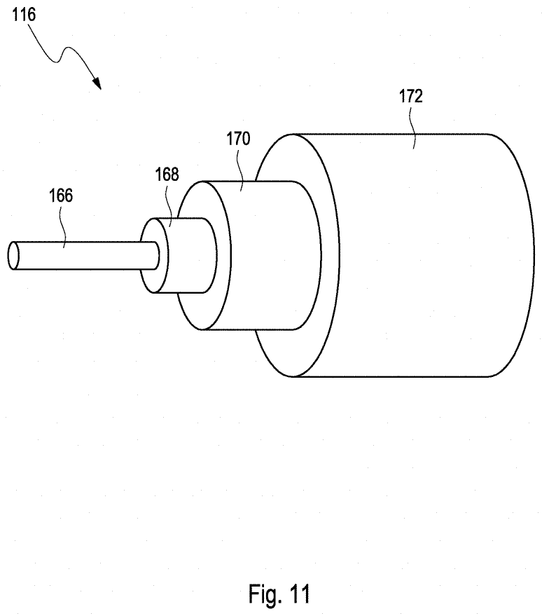

FIG. 11 shows a highly schematic view of an embodiment of an optical receiving fiber 116. Each of the optical receiving fibers 116 may comprise the at least one fiber core 166 which is surrounded by the at least one fiber cladding 168. The fiber cladding 168 may have a lower index of refraction as the fiber core 166. The fiber cladding 168 may also be a double or multiple cladding. The fiber cladding 168 may be surrounded by a buffer 170 and an outer jacket 172. The fiber cladding 168 may be coated by the buffer 170 which is adapted to protect the optical receiving fiber 116 from damages and moisture. The buffer 170 may comprise at least one UV-cured urethane acrylate composite and/or at least one polyimide material.

In order to assess the measurement stability of the measurement head 110, in an experimental setup, 20 mm spark gaps with each 25 kV were placed on each side of the measurement head 110 in a distance of 20 mm to the measurement head 110. Sparks were fired alternatingly on each side of the measurement head 110. In a length of 200 mm of the optical receiving fibers 116 including the measurement head 110 and the spark gaps were placed in a climate chamber and heated in steps of 20K to a maximum temperature Tₘₐₓ. A target with 50% reflectivity was placed at 50 mm distance. The experiment was performed for optical fibers and transfer devices of different materials. For example, silica, acrylic and sapphire fibers were tested. The lens material of the transfer device was diamond, sapphire, float glass CaF₂, Teflon, Acryl or silica. The measurement error Δz was determined as the standard deviation for 10.000 measurements.

The results in the following table clearly show a lower measurement error Δz for εᵣ/k≥0.362 (m·K)/W compared to lower ratios.

| Fiber material | Lens material | Tₘₐₓ in ° C. | Δz in mm | εᵣ/k in (m · K)/W |
|---|---|---|---|---|
| Silica | Diamond | 180 | 3.3 | 0.006 (Lens) |
| Silica | Sapphire | 180 | 2.9 | 0.25 (Lens) |
| Silica | Float Glass | 180 | 0.8 | 4 (Lens) |
| Silica | CaF₂ | 180 | 3.7 | 0.15 (Lens) |
| Silica | Teflon | 180 | 1.3 | 8.4 (Lens) |
| Silica | Acrylic | 180 | 1.2 | 13.5 (Lens) |
| Acrylic | Acrylic | 180 | 1.4 | 13.5 (Both) |
| Sapphire | Sapphire | 180 | 3.0 | 0.25 (Fiber) |
| Sapphire | Silica | 180 | 2.5 | 0.25 (Fiber) |

### LIST OF REFERENCE NUMBERS

110 Measurement head
112 Object
114 Transfer device
116 Optical receiving fiber
118 Entrance face
120 Optical axis
122 Light beam
124 Spacer device
126 kit
128 detector
130 Illumination source
132 Light source
134 Optical illumination fiber
136 Light beam
138 Exit face
140 optical sensor
142 First optical sensor
144 Second optical sensor
146 Light-sensitive area
148 Evaluation device
150 divider
152 position evaluation device
154 Entrance end
156 Exit end
158 Fourth fiber
160 first optical receiving fiber
162 Second optical receiving fiber
164 actuator
166 core
168 cladding
170 buffer
172 Outer jacket

1. A measurement head (110) for determining a position of at least one object (112) comprising:
at least one transfer device (114), wherein the transfer device (114) has at least one focal length in response to the at least one incident light beam (122) propagating from the object (112) to the measurement head (110); and
at least two optical receiving fibers (116), wherein at least one of the optical receiving fibers (116) and/or the transfer device (114) has a ratio εᵣ/k≥0.362 (m·K)/W, wherein k is the thermal conductivity and εᵣ is the relative permittivity.

2. The measurement head (110) according to claim 1, wherein at least one of the optical receiving fibers (116) and/or the transfer device (114) has the ratio εᵣ/k≥0.743 (m·K)/W.

3. The measurement head (110) according to claim 1, wherein the ratio εᵣ/k is in a range 0.362 (m·K)/W≤εᵣ/k≤1854 (m·K)/W.

4. The measurement head (110) according to claim 1, wherein the transfer device (114) has a ratio νₑ/n_{D} in a range 9.05≤νₑ/n_{D}≤77.3, wherein νₑ is the Abbé-number and n_{D} is the refractive index, wherein the Abbé-number νₑ is given by wherein n_{D} is the refractive index for different wavelengths, wherein n_{C} is the refractive index for 656 nm, n_{D} is the refractive index for 589 nm and n_{F} is the refractive index for 486 nm.

5. The measurement head (110) according to claim 1, wherein a product αΔn is αΔn≤110 dB/km at at least one wavelength in a visual and near infrared wavelength range, wherein α is the attenuation coefficient and Δn is the refractive index contrast with Δn=(n12−n22)/(2n12), wherein n1 is the maximum core refractive index and n2 is the cladding refractive index.

6. The measurement head (110) according to claim 5, wherein the product α Δn is α Δn≤23 dB/km.

7. The measurement head (110) according to claim 1, wherein the transfer device (114) has an aperture area D₁ and at least one of the optical receiving fibers (116) has a fiber core (166) with a cross-sectional area D₂, wherein a ratio D₁/D₂ is in a range 0.54≤D₁/D₂≤5087.

8. The measurement head (110) according to claim 1, wherein the measurement head (110) comprises at least one spacer device (124), wherein the spacer device (124) is configured for connecting the at least one transfer device (114) and at least one of the optical receiving fibers (116).

9. The measurement head (110) according to claim 8, wherein the spacer device (124) comprises a solid volume Vₛ and a hollow volume Vₕ, wherein a ratio of solid volume and hollow volume Vₛ/Vₕ is in a range 0.013≤Vₛ/Vₕ≤547.

10. The measurement head (110) according to claim 1, wherein the measurement head (110) further comprises an illumination source (130) for illuminating the object (112), wherein the illumination source (130) has a geometrical extend G in a range 1.5·10⁻⁷ mm²·sr≤G≤314 mm².

11. The measurement head (110) according to claim 1, wherein each optical receiving fiber (116) comprises the at least one fiber cladding (168) and the at least one core (166), wherein a ratio d₁/BL is in a range 0.0011≤d₁/BL≤513, where d₁ is the diameter of the core (166) and BL is a baseline.

12. The measurement head (110) according to claim 1, wherein each optical receiving fiber (116) has at least one entrance face (118), wherein a geometric center of the respective entrance face (118) is aligned perpendicular with respect to an optical axis (120) of the transfer device (114).

13. The measurement head (110) according to claim 1, wherein at least one of the optical receiving fibers (116) is a structured fiber having a shaped and/or structured entrance (118) and/or exit face.

14. The measurement head (110) according to claim 1, wherein the measurement head (110) comprises at least one actuator (164) configured to move the measurement head (110) to scan a region of interest.

15. A kit (126) comprising at least one measurement head (110) according to claim 1 and a detector (128) for determining a position of at least one object (112), the detector (128) comprising:
at least two optical sensors (140), wherein each optical sensor (140) has at least one light sensitive area (146), wherein each optical sensor (140) is designed to generate at least one sensor signal in response to an illumination of its respective light-sensitive area (146) by a light beam having passed through at least one of the optical receiving fibers (116) of the measurement head (110); and
at least one evaluation device (148) being configured for determining at least one longitudinal coordinate z of the object (112) by evaluating a combined signal Q from the sensor signals.

16. The kit (126) according to claim 15, wherein the evaluation device (148) is configured for deriving the combined signal Q by one or more of dividing the sensor signals, dividing multiples of the sensor signals, or dividing linear combinations of the sensor signals.

17. The kit (126) according to claim 16, wherein the evaluation device (148) is configured for using at least one predetermined relationship between the combined signal Q and the longitudinal coordinate for determining the longitudinal coordinate.

18. The kit (126) according to claim 15, wherein the optical sensors (140) are partial diodes of a bi-cell or quadrant diode and/or comprise at least one CMOS sensor.

19. A method for determining a position of at least one object (112), the method comprising the following steps:
providing at least one measurement head (110), the measurement head (110) comprising:
at least one transfer device (114), wherein the transfer device (114) has at least one focal length in response to the at least one incident light beam (122) propagating from the object (112) to the measurement head (110);
at least two optical receiving fibers (116), wherein at least one of the optical receiving fibers (116) and/or the transfer device (114) has a ratio εᵣ/k≥0.362 (m·K)/W, wherein k is the thermal conductivity and εᵣ is the relative permittivity;
providing at least one detector (128), the detector (128) comprising at least two optical sensors (140), wherein each optical sensor (140) has at least one light-sensitive area (146), wherein each optical sensor (140) is designed to generate at least one sensor signal in response to an illumination of its respective light-sensitive area (146) by a light beam having passed through at least one of the optical receiving fibers (116) of the measurement head (110);
illuminating each light-sensitive area (146) of at least two optical sensors (140) of the detector (128) with at least one light beam having passed through at least one of the optical receiving fibers (116), wherein, thereby, each of the light-sensitive areas (146) generates at least one sensor signal; and
evaluating the sensor signals, thereby, determining at least one longitudinal coordinate z of the object (112), wherein the evaluating comprises deriving a combined signal Q of the sensor signals.

20. A method of using the measurement head (110) according to claim 1, the method comprising using the measurement head (110) for a purpose, selected from the group consisting of: a position measurement in traffic technology; an entertainment application; an optical data storage application; a security application; a surveillance application; a safety application; a human-machine interface application; a logistics application; an endoscopy application; a medical application; a tracking application; a photography application; a machine vision application; a robotics application; a quality control application; a 3D printing application; an augmented reality application; a manufacturing application; and a purpose in combination with optical data storage and readout.
